(19) United States
(12) Patent Application Publication
(10) Pub. No.: US 2026/0120570 A1
(43) Pub. Date: Apr. 30, 2026

(54) ENTERPRISE ACTIVE SAFETY SYSTEM

(71) Applicant: CAVH LLC, Fitchburg, WI (US)

(72) Inventors: Bin Ran, Fitchburg, WI (US); Sicheng Fu, Fitchburg, WI (US); Yifan Yao, Fitchburg, WI (US); Yang Cheng, Fitchburg, WI (US); Keshu Wu, Fitchburg, WI (US); Jingwen Zhu, Fitchburg, WI (US); Junwei You, Fitchburg, WI (US); Rui Gan, Fitchburg, WI (US); Bingjie Liang, Fitchburg, WI (US); Xiaoying Yi, Fitchburg, WI (US); Junyi Ma, Fitchburg, WI (US); Weizhe Tang, Fitchburg, WI (US)

(21) Appl. No.: 19/372,938

(22) Filed: Oct. 29, 2025

Related U.S. Application Data
(60) Provisional application No. 63/713,892, filed on Oct. 30, 2024.

(51) Int. Cl. G08G 1/16; G08G 1/01; G08G 1/0967

(52) U.S. Cl. CPC G08G 1/164; G08G 1/0129; G08G 1/0133; G08G 1/0141; G08G 1/0145; G08G 1/096725; G08G 1/166

(57) ABSTRACT

Provided herein is technology relating to automated driving, particularly, but not exclusively, to an enterprise active safety system (EASS) that is configured to improve safety or minimize losses from safety events. More specifically, the EASS is configured to provide system-based safety functions by integrating one or more of the vehicle components, road components, cloud components, pedestrian components, and map components. These safety functions include one or more of crash detection, crash prediction, crash warning, crash avoidance, crash impact reduction, and emergency response functions.

### CROSS-REFERENCE TO RELATED APPLICATION

This application claims the benefit of U.S. Provisional Patent Application No. 63/713,892, filed Oct. 30, 2024, which is incorporated by reference herein in its entirety.

### FIELD

Provided herein is technology relating to intelligent driving, particularly, but not exclusively, to an Enterprise Active Safety System (EASS) configured to improve safety or minimize losses from safety events. More specifically, the EASS is configured to provide system-based safety functions by integrating one or more of the vehicle components, road components, cloud components, pedestrian components, and map components. These safety functions include one or more of crash detection, crash prediction, crash warning, crash avoidance, crash impact reduction, and emergency response functions.

### BACKGROUND

Ensuring the safe operation of an Autonomous Vehicle (AV) or a Connected Automated Vehicle (CAV) is important for realizing their transformative potential in modern transportation. As CAV technology advances, incorporating intelligent driving capabilities becomes increasingly crucial. These systems integrate real-time data analysis, machine learning algorithms, and sensor technologies to enhance decision-making and responsiveness on the road. By leveraging intelligent driving, CAVs adapt to dynamic traffic conditions, anticipate potential hazards, and execute maneuvers precisely while prioritizing safety. This holistic safe system approach to vehicle automation and proactive safety not only enhances passenger comfort and convenience, but also reinforces trust and confidence in the reliability and security of AV technology among both passengers and fellow road users.

### SUMMARY

Recently, advancements in technology have been developed to address these challenges. One notable example is the Collaborative Automated Driving System (CADS). See, e.g., U.S. Pat. App. Pub. No. 2022/0270476 (U.S. patent application Ser. No. 17/667,683), incorporated herein by reference. This system, or its components, represents a significant step forward in addressing safety concerns associated with Autonomous Vehicle (AV) or Connected Automated Vehicle (CAV) technologies. The CADS framework provides a comprehensive suite of subsystems, including the cooperative management subsystem, road subsystem, vehicle subsystem, communication subsystem, user subsystem, and supporting subsystem. Notably, the technology herein relates to intelligent driving, with a specific focus on an Enterprise Active Safety System (EASS). This EASS leverages sophisticated artificial intelligence (AI) models to enhance safety measures and mitigate losses stemming from safety-related incidents, thus integrating present AI technologies with automotive safety technology.

As described herein, embodiments of technology provide safety technology that integrates a number of components for both human-driven vehicles and intelligent driving systems. This integrated system comprises vehicle components, road infrastructure components, cloud-based system components, pedestrian components, and map components. Through this approach, the technology provides a range of safety features for different scenarios. These features include functions of crash detection, prediction, warning, avoidance, impact reduction, and emergency response. By incorporating intelligent driving principles, the system dynamically adapts to changing road conditions and user behavior, further enhancing safety for all road users.

In some embodiments, the entire EASS is hosted on one or more of five distinct components: a vehicle component, a road component, a cloud component, a pedestrian component, and/or a map component. In some embodiments, the pedestrian component comprises a pedestrian component and/or a non-automated vehicle component. In some embodiments, the road component comprises one or more of a road component, a roadside component, a mobile roadside component, and an edge server road component.

In some embodiments, the EASS comprises one or more of the following subsystems empowered by the AI model: a Crash Detection Subsystem, a Crash Prediction Subsystem, a Crash Warning Subsystem, an EASS Crash Avoidance Subsystem, a Crash Impact Reduction Subsystem, an Emergency Response Subsystem, and/or a Management and Service Subsystem.

In some embodiments, the EASS is hosted on one or more of the following components: a vehicle component, a road component, a cloud component, a pedestrian component, and/or a map component. The EASS provides services to users, which include vehicles, agencies, pedestrians, auto-companies, and tech-companies. The EASS also provides services to applications, including service applications and management applications. The EASS has data exchange with data resources. The data resources of the EASS include vehicle, road, cloud, map, pedestrian, and third party.

In some embodiments, the Management and Service Subsystem sends historical safety data from the Historical Safety Data Module to several subsystems, including the Crash Detection Subsystem, Crash Prediction Subsystem, Crash Warning Subsystem, Crash Avoidance Subsystem, Crash Impact Reduction Subsystem, and Emergency Response Subsystem.

The Management and Service Subsystem manages data flow between each subsystem. In some embodiments, the Crash Detection Subsystem receives historical safety data from the Historical Safety Data Module of the Management and Service Subsystem and sends detection results to the Crash Prediction Subsystem and the Storage and Backup Module. The Crash Prediction Subsystem receives detection results from the Crash Detection Subsystem. The prediction results, as the output of the Crash Prediction Subsystem, are sent to the Storage and Backup Module of the Management and Service Subsystem.

The Management and Service Subsystem identifies whether the probability of a crash is over a predetermined threshold. If the probability of the crash is over the threshold, the Management and Service Subsystem sends detection results and prediction results to the Crash Avoidance Subsystem. At the same time, the Management and Service Subsystem identifies whether the driving scenario is normal or not. If the driving scenario is not normal, the Management and Service Subsystem sends prediction results to the Crash Warning Subsystem. The warning results, as the output of the Crash Warning Subsystem, are sent to the Storage and Backup Module of the Management and Service Subsystem. If the driving scenario is normal, the Management and Service Subsystem identifies whether the probability of the crash is over the predetermined threshold. If the probability of the crash is over the threshold, the Management and Service Subsystem sends the detection result and prediction result to the Crash Avoidance Subsystem. The avoidance results, as the output of the Crash Avoidance Subsystem, are sent to the Storage and Backup Module of the Management and Service Subsystem.

The Management and Service Subsystem identifies whether the vehicle can avoid the crash. If the vehicle can avoid the crash, it sends the avoidance result to the Storage and Backup Module to store and backup. If the vehicle cannot avoid the crash, the Management and Service Subsystem sends avoidance results to the Crash Impact Reduction Subsystem and the Emergency Response Subsystem. The impact reduction results and emergency response results, as the output of these two subsystems, are sent to the Storage and Backup Module of the Management and Service Subsystem.

Subsequently, the Management and Service Subsystem identifies whether trip has ended. If the trip has ended, the Management and Service Subsystem stores and backups the trip information in the Storage and Backup Module of the Management and Service Subsystem. If the trip has not ended, the Management and Service Subsystem goes back to the Historical Safety Data Module and sends historical data to all subsystems. The data in the Historical Safety Data Module is updated by the Storage and Backup Module at each time step.

In some embodiments, the Crash Detection Subsystem comprises a Data Processing Unit, a Coordination Unit, a Crash Identification Unit, and a Crash Validation Unit. In some embodiments, the Data Processing Unit of the Crash Detection Subsystem first receives information from one or more of the vehicle component, the road component, the cloud component, the pedestrian component, and/or the map component. It also receives historical data from the Management and Service Subsystem. Following the data processing, the Coordination Unit processes the collected information and then fuses the processed information. Finally, the Crash Identification Unit and the Crash Validation Unit collaborate to identify each crash type and severity level and validate the accuracy and confidence of each identified crash data.

In some embodiments, the Crash Identification Unit determines whether the crash has already occurred. If the crash has occurred, it identifies the severity level of the crash, and the Crash Validation Unit validates the results. The Crash Detection Subsystem sends crash results to the Crash Warning Subsystem, the Crash Avoidance Subsystem, the Emergency Response Subsystem, and the Crash Management and Service Subsystem. Otherwise, if the crash has not occurred, the Crash Identification Unit determines whether it is a near miss. In some embodiments, if the Crash Identification Unit identifies the near miss, the Crash Detection Subsystem sends the near miss results to the Crash Prediction Subsystem, the Crash Warning Subsystem, the Crash Avoidance Subsystem, and the Management and Service Subsystem. Otherwise, if the Crash Identification Unit does not identify the near miss, the Crash Detection Subsystem sends the results to all six other subsystems.

In some embodiments, the Crash Prediction Subsystem comprises one or more of the following units: a Data Fusion Unit, a Data Processing Unit, a Prediction Unit, and/or an Assessment Unit. In some embodiments, the Data Fusion Unit is configured to integrate real-time data with data from one or more of the following sources: real-time data from the Crash Detection Subsystem, historical data from the Management and Service Subsystem, predicted data from other surrounding vehicles, and status data from the vehicle and traffic infrastructure. In some embodiments, the Data Processing Unit is configured to clean, transform, and organize the collected data from the Crash Detection Subsystem, historical data from the Management and Service Subsystem, predicted data from other surrounding vehicles, and status data from the vehicle and traffic infrastructure to create a structured input for prediction.

In some embodiments, the Prediction Unit is configured to utilize large-scale models to predict risk assessment for individual vehicles, wherein a large-scale model refers to a complex computational structure capable of processing and analyzing vast amounts of data from multiple sources, which includes Deep Reinforcement Learning models and Graph Transformers models known for their ability to identify intricate patterns within large datasets and parameters. In some embodiments, the Assessment Unit is configured to assess the risk level and evaluate potential collision scenarios, including Fatality, Serious Injury, Minor Injury, Near Miss, and Unsafe Act.

In some embodiments, the Data Fusion Unit collects and integrates collected data from other sources, including the Crash Detection Subsystem, the Management and Service Subsystem, and other surrounding vehicles and infrastructure to produce integrated data, and sends the integrated data to the Data Processing Unit to clean, transform, and organize the integrated data to create a structured input data for prediction. The Prediction Unit utilizes models to generate prediction probability for the individual vehicle, and the Assessment Unit evaluates these predictions, assessing the risk levels and potential collision scenarios, including Fatality, Serious Injury, Minor Injury, Near Miss, and Unsafe Act. The output of the Crash Prediction Subsystem, which comprises the predicted probability of each risk scenario, is sent to individual vehicles, the Management and Service Subsystem, and one of the following subsystems: Crash Warning Subsystem, Crash Avoidance Subsystem, Crash Impact Reduction Subsystem, and Emergency Response Subsystem.

In some embodiments, the Crash Warning Subsystem comprises a Data Processing Unit, a Warning Message Computing Unit, a Warning Execution Unit, and a Warning Recording Unit. The Data Processing Unit is configured to receive and process incident information. The incident information encompasses data pertinent to vehicular accidents, adverse weather conditions, and construction disruptions from a number of subsystems. The Data Processing Unit assimilates incident information, which potentially includes historical data retrieved from the Management and Service Subsystem, and processes it to discern incidents that necessitate warnings.

The Warning Message Computing Unit is designed to generate computed messages that are specifically tailored for a diverse set of recipients, which include vehicles, road infrastructure, cloud-based services, pedestrians, and map systems. The purpose of these computed messages is to initiate warnings on corresponding devices, ensuring that each entity is apprised of the potential hazard in a timely and effective manner. The Warning Execution Unit is responsible for the actual implementation of the warning procedures upon the identification of a risk by the Warning Message Computing Unit. The warning includes deploying audible alarms, visual alerts, or other notification mechanisms to prevent imminent crashes by alerting the relevant entities. The Warning Recording Unit maintains a comprehensive record of all issued warnings, the incidents that precipitated these warnings, and any subsequent outcomes. The Warning Recording Unit is crucial for continuously enhancing the warning system and providing an essential database for analytical, legal, and regulatory purposes.

In some embodiments, the Crash Warning Subsystem is configured to receive three inputs: real-time data from the Crash Detection Subsystem, prediction data from the Crash Prediction Subsystem, and historical data from the Management and Service Subsystem.

In some embodiments, the Crash Warning Subsystem is configured to output two primary forms of data: Real-time Warning and Offline Warning. The Real-time Warning data is directed to the Crash Impact Avoidance Subsystem, and the Offline Warning data is directed to the Management and Service Subsystem.

In some embodiments, the Crash Avoidance Subsystem comprises a Data Processing Unit, and one or more of the following: a Crash Avoidance Assistant Unit, a Vehicle Control and Coordination Unit, a Vehicle Takeover and Control Unit, a Human Takeover and Control Unit, and/or a Generative Computation and Simulation Unit. In some embodiments, the Data Processing Unit receives and processes the input data from other subsystems. In some embodiments, the Crash Avoidance Assistant Unit analyzes the feasibility of crash avoidance and provides a crash avoidance strategy to support crash avoidance. In some embodiments, the Vehicle Control and Coordination Unit coordinates other vehicles to be involved in the potential crash and sends control instructions to other vehicles to support crash avoidance. In some embodiments, the Vehicle Takeover and Control Unit provides takeover and control of the vehicle by the road component, the edge component, and/or the cloud component to support crash avoidance. In some embodiments, the Human Takeover and Control Unit provides takeover and control by the human driver to support crash avoidance. In some embodiments, the Generative Computation and Simulation Unit provides scene construction, event modeling, and generative simulation to generate an optimal crash avoidance plan.

In some embodiments, the Crash Avoidance Subsystem receives input data and determines whether the operation is for in vehicle units or for external units. If the operation is for in vehicle unit, the subsystem will further determine whether the vehicle can avoid the crash. If the vehicle can avoid the crash, the vehicle notifies other vehicles of the crash risk, and the subsystem provides control instructions to the vehicle. If the vehicle cannot avoid the crash, the subsystem further determines whether support from the road component, the edge component, and/or the cloud component is available. If available, the road component, the edge component, and/or the cloud component notifies or warns other vehicles of the potential crash, and then provides support and/or control to the vehicle. Otherwise, the vehicle notifies and/or warns other vehicles of the potential crash.

On the other hand, if the operation is for an outside vehicle unit, the subsystem determines whether objects outside the vehicle will be influenced. If the objects outside the vehicle are influenced, the vehicle component, road component, and/or cloud component notify other vehicles of the potential crash. The subsystem coordinates outside objects to support avoidance of the crash. Finally, the subsystem determines whether the crash can be successfully avoided. If the crash can be avoided, the subsystem sends successful avoidance and near-miss results to the Management and Service Subsystem. Otherwise, the Crash Avoidance Subsystem prepares emergency responses and sends them to the Emergency Response Subsystem. Then, the Crash Avoidance Subsystem prepares a crash impact reduction plan and sends it to the Crash Impact Reduction Subsystem.

In some embodiments, the Crash Impact Reduction Subsystem comprises a Data Processing Unit and an Assessment Unit. In some embodiments, the Crash Impact Reduction Subsystem further comprises one or more of a Crash Digital Twin Unit, a Candidate Strategy Generation Unit, and/or a Takeover and Control unit. In some embodiments, the Data Processing Unit integrates the crash detection results, crash prediction results, crash warning results, crash avoidance results, and historical safety data, providing a comprehensive information foundation for all levels. In some embodiments, the Assessment Unit offers quantitative risk assessments for all levels, aiding the system in decision-making across different scenarios.

In some embodiments, the Data Processing Unit receives the crash detection results from the Crash Detection Subsystem, crash prediction results from the Crash Prediction Subsystem, crash warning results from Crash Warning Subsystem, crash avoidance results from Crash Avoidance Subsystem, and historical safety data from the Management and Service Subsystem to provide comprehensive and up-to-date information for the crash impact reduction process. In some embodiments, the Crash Digital Twin Unit simulates traffic crashes by modeling vehicle dynamics, road conditions, and environmental variables to predict collision scenarios and their potential impact on vehicle occupants and surroundings. In some embodiments, the Candidate Strategy Generation Unit analyzes the simulated data from the Crash Digital Twin Unit and generates a set of horizontal and vertical control commands aimed at reducing crash impact. In some embodiments, the Assessment Unit quantitatively evaluates the risks associated with each command and their expected benefits in terms of safety and overall system performance. In some embodiments, the Takeover and Control Unit can take control of vehicles by generating and sending control instructions and send information to the Management and Service Subsystem for backup.

In some embodiments, when the Assessment Unit estimates that the probability of a crash exceeds a predefined threshold, the Crash Digital Twin Unit accelerates the simulation speed akin to a time machine. Subsequently, the Candidate Strategy Generation Unit analyzes the data generated by the Crash Digital Twin Unit to generate various horizontal and vertical control commands. Additionally, following a crash, the Crash Digital Twin Unit can retrospect the crash process, facilitating the determination of the accident's cause.

In some embodiments, the Crash Impact Reduction Subsystem is applicable to autonomous driving levels ranging from L1 to L5. At the L1 level, the Crash Impact Reduction Subsystem implements collision warning and auxiliary braking and supports the drivers in making safe driving decisions through the data processing unit. At the L2/L3 level, the Crash Impact Reduction Subsystem realizes automatic emergency braking through the Crash Digital Twin Unit and Data Processing Unit to mitigate collision impact. The Crash Digital Twin Unit and Candidate Strategy Generation Unit generate multiple horizontal and vertical control commands to mitigate collision impact. The Assessment Unit evaluates the risks and expected benefits of commands, supporting more autonomous decision-making. At the L4/L5 level, the Crash Impact Reduction Subsystem implements automatic takeover and control. The Takeover and Control Unit proactively takes control measures, automatically operating the vehicle based on the risk assessment. The L4/L5 level can achieve advanced crash impact functions through all units to support highly autonomous driving tasks.

In some embodiments, the Emergency Response Subsystem comprises an Emergency Alert Unit, and one or more of the following: a Minor Injury Response Unit, a Major Injury Response Unit, a Hazardous Material Removal and Risk Mitigation Unit, and a Road Clearance and Traffic Recovery Unit. In some embodiments, while the emergency event occurs, the Emergency Alert Unit, resided in the vehicle, contacts law enforcement for actions and sends an emergency alert to other vehicles immediately. In the event of a crash resulting in injuries, the response protocol is determined by the severity of the injuries sustained. For major injuries, the Major Injury Response Unit, resided in the cloud component, immediately requests the fire department, communicates with public safety communications (E911), and requests Emergency Medical Services (EMS) to ensure people's safety. In cases of minor injuries, the Minor Injury Response Unit, resided in the road component or edge component, requests the assistance of Emergency Medical Services (EMS) to provide medical treatment and related services. If there are hazardous materials, the Hazardous Material Removal and Risk Mitigation Unit resided in the road component or edge component requests hazardous material removal and risk mitigation services. The Road Clearance and Traffic Recovery Unit, resided in the cloud component, requests towing and traffic recovery services.

### BRIEF DESCRIPTION OF THE DRAWINGS

FIG. 1 shows the host components of the Enterprise Active Safety System (EASS).

FIG. 2 shows an exemplary component of the EASS.

FIG. 3 shows the system structure of the EASS.

FIG. 4 shows an exemplary basic structure of the Management and Service Subsystem.

FIG. 5 shows the workflow of the Management and Service Subsystem.

FIG. 6 shows the management and allocation process of the Management and Service Subsystem.

FIG. 7 shows the architecture of the Crash Detection Subsystem.

FIG. 8 identifies the Crash Severity Classification.

FIG. 9 shows the input data of Crash Detection Subsystem.

FIG. 10 shows the output data of Crash Detection Subsystem.

FIG. 11 shows the workflow of the Crash Detection Subsystem.

FIG. 12 shows an exemplary basic structure and data flow of the Crash Prediction Subsystem.

FIG. 13 shows a flowchart of the Crash Prediction Subsystem.

FIG. 14 shows exemplary input data of the Crash Prediction Subsystem.

FIG. 15 shows exemplary output data of the Crash Prediction Subsystem.

FIG. 16 shows the exemplary prediction level of the Crash Prediction Subsystem.

FIG. 17 shows an exemplary structure of Crash Warning Subsystem.

FIG. 18 presents a schematic of the Crash Warning Subsystem workflow.

FIG. 19 shows the input data of the Crash Warning Subsystem.

FIG. 20 shows the output data of Crash Detection Subsystem.

FIG. 21 shows an exemplary basic structure of the Crash Avoidance Subsystem.

FIG. 22 shows the workflow of the Crash Avoidance Subsystem.

FIG. 23 shows the input data of the Crash Avoidance Subsystem.

FIG. 24 shows the output data of the Crash Avoidance Subsystem.

FIG. 25 shows the components of the Crash Impact Reduction Subsystem.

FIG. 26 shows the information flow of the Crash Impact Reduction Subsystem.

FIG. 27 shows the flowchart of the Crash Impact Reduction Method.

FIG. 28 shows the examples of application for the Crash Impact Reduction Subsystem.

FIG. 29 shows the components of the Emergency Response Subsystem.

FIG. 30 shows the host of each unit of the Emergency Response Subsystem.

FIG. 31 shows the input and output of the Emergency Response Subsystem.

FIG. 32 shows the workflow of the Emergency Response Subsystem.

Before any embodiments are explained in detail, it is to be understood that the present disclosure is not limited in its application to the details of construction and the arrangement of components set forth in the following description or illustrated in the accompanying drawings. The present disclosure is capable of other embodiments and of being practiced or of being carried out in various ways.

### DRAWING PART NUMBERS

001: Enterprise Active Safety System
002: Map Component
003: Vehicle Component
004: Cloud Component
005: Road Component
006: Pedestrian Component
101: Enterprise Active Safety System
102: Crash Detection Subsystem
103: Crash Prediction Subsystem
104: Crash Warning Subsystem
105: EASS Crash Avoidance Subsystem
106: Crash Impact Reduction Subsystem
107: Emergency Response Subsystem
108: Management and Service Subsystem
301: Host Components
302: Vehicle Component
303: Cloud Component
305: Map Component
306: Pedestrian Component
307: Third Party
308: Data Resource
309: Indication of Host Components for EASS
310: Providing Service to User
311: Data Exchange between EASS and Data Resource
312: Providing Service to Application
313: User
314: Application
315: Vehicle
316: Agency
317: Pedestrian
318: Auto-company
319: Tech-company
320: Service Application
321: Management Application
401: Management and Service Subsystem
402: Data Storage and Backup Module
403: Management and Allocation Module
404: Update and Maintenance Software Module
405: Historical Safety Data
701: EASS Crash Detection Subsystem
702: Data Processing Unit
703: Coordination Unit
704: Crash Identification Unit
705: Crash Validation Unit
801: Crash Severity Classification
802: Fatality
803: Serious Injury
804: Minor Injury
805: Property Damage
806: Near Miss
807: Unsafe Act
808: Quantity
809: Severity
901: EASS Crash Detection Subsystem
902: Vehicle
903: Road
904: Cloud
905: Pedestrian/Non-automated Vehicle
906: Map
907: Historical Data
908: EASS Crash Management and Service Subsystem
1001: EASS Crash Detection Subsystem
1002: Crash has occurred
1003: Crash about to occur
1004: Near Miss and Unsafe Act
1005: Emergency Response Subsystem
1006: Crash Impact Reduction Subsystem
1007: Crash Prediction Subsystem
1008: Crash Warning Subsystem
1009: Crash Avoidance Subsystem
1010: Crash Management and Service Subsystem
1201: Crash Prediction Subsystem
1202: Data Fusion Unit
1203: Data Processing Unit
1204: Prediction Model
1205: Assessment Model
1206: Vehicle Detection Subsystem
1207: Management and Service Subsystem
1208: Crash Warning Subsystem
1209: Crash Avoidance Subsystem
1210: Crash Impact Reduction Subsystem
1211: Emergency Response Subsystem
1401: Vehicle Detection Data
1402: Vehicle Status Data
1403: Road Detection Data
1404: Cloud Detection Data
1405: Pedestrian/Non-automated Data
1406: Map Data
1407: Historical Data from Management and Service Subsystem
1408: Crash Prediction Subsystem
1501: Crash Prediction Subsystem
1502: Risk Assessment Output
1503: Fatality
1504: Serious Injury
1505: Minor Injury
1506: Near Miss
1507: Unsafe Act
1508: Crash Warning Subsystem
1509: Crash Avoidance Subsystem
1510: Crash Impact Reduction Subsystem
1511: Emergency Response Subsystem
1512: Management and Service Subsystem
1601: Input Data
1602: Microscopic Level Prediction
1603: Mesoscopic Level Prediction
1604: Macroscopic Level Prediction
1605: Output Data
1606: Crash Prediction Subsystem
1701 EASS Crash Warning Subsystem
1702 Data Processing Unit
1703 Warning Message Computing Unit
1704 Warning Execution Unit
1705 Warning Fusion Unit
1901 Crash Warning Subsystem
1902 Crash Detection Subsystem
1903 Crash Prediction Subsystem
1904 Management and Service Subsystem
1905 Real-time Data
1906 Prediction Data
1907 Historical Data
2001 Crash Warning Subsystem
2002 Real-time Warning
2003 Offline Warning
2004 Crash Impact Avoidance Subsystem
2005 Management and Service Subsystem
2101: EASS Crash Avoidance Subsystem
2102: Data Processing Unit
2103: Crash Avoidance Assistant Unit
2104: Vehicle Control and Coordination Unit
2105: Vehicle Takeover and Control Unit
2106: Human Takeover and Control Unit
2107: Generative Computation and Simulation Unit
2301: EASS Crash Avoidance Subsystem
2302: Crash Detection Subsystem
2303: Crash Prediction Subsystem
2304: Crash Warning Subsystem
2305: Management and Service Subsystem
2306: Detection Results from Crash Detection Subsystem
2307: Prediction Results from Crash Prediction Subsystem
2308: Warning Output from Crash Warning Subsystem
2309: Historical Safety Data from Management and Service Subsystem
2401: EASS Crash Avoidance Subsystem
2402: Emergency Response Subsystem
2403: Crash Impact Reduction Subsystem
2404: Management and Service Subsystem
2405: Potential Crash Avoidance and Emergency Response
2406: Failed Crash Avoidance and Crash Impact Reduction Plan
2407: Successful Avoidance Results and Near Miss Results
2501: Crash Impact Reduction Subsystem
2502: Data Processing Unit
2503: Crash Digital Twin Unit
2504: Candidate Strategy Generation Unit
2505: Assessment Unit
2506: Takeover and Control Unit
2601: Crash Detection Subsystem
2602: Crash Prediction Subsystem
2603: Crash Warning Subsystem
2604: Crash Avoidance Subsystem
2605: Management and Service Subsystem
2606: Crash Detection Results
2607: Crash Prediction Results
2608: Crash Warning Results
2609: Crash Avoidance Results
2610: Historical Safety Data
2611: Crash Impact Reduction Subsystem
2612: Data Processing Unit
2613: Processed Data
2614: Assessment Unit
2615: Probability of the Crash Occurring
2616: Crash Digital Twin Unit
2617: Results of Crash Simulation
2618: Candidate Strategy Generation Unit
2619: Horizontal and Vertical Control Commands
2620: Risks and Expected Benefits
2621: Takeover and Control Unit
2622: Crash Impact Reduction Results
2623: Emergency Response Subsystem
2624: Vehicles
2801: Crash Impact Reduction Subsystem Example
2802: Vehicle
2803: Pre-crash Seatbelt
2804: Pre-crash Brake Assist
2805: Road
2806: Roadside Airbag
2807: Cloud
2808: Wireless Communication Module
2901: Emergency Response Subsystem
2902: Emergency Alert Unit
2903: Minor Injury Response Unit
2904: Major Injury Response Unit
2905: Hazardous Material Removal and Risk Mitigation Unit
2906: Road Clearance and Traffic Recovery Unit
3001: Emergency Response Subsystem
3002: Vehicle
3003: Cloud
3004: Road
3005: Road
3006: Cloud
3007: Emergency Alert Unit
3008: Major Injury Response Unit
3009: Minor Injury Response Unit
3010: Hazardous Material Removal and Risk Mitigation Unit
3011: Road Clearance and Traffic Recovery Unit
3101: Emergency Response Subsystem
3102: Management and Service Subsystem
3103: Crash Detection Subsystem
3104: Crash Prediction Subsystem
3105: Crash Warning Subsystem
3106: Crash Avoidance Subsystem
3107: Crash Impact Reduction Subsystem
3108: Crash Detection Results
3109: Crash Prediction Results
3110: Crash Warning Output
3111: Crash Avoidance Results
3112: Crash Reduction Results
3113: Historical Safety Data
3114: Emergency Response Output

### DETAILED DESCRIPTION OF THE DRAWINGS

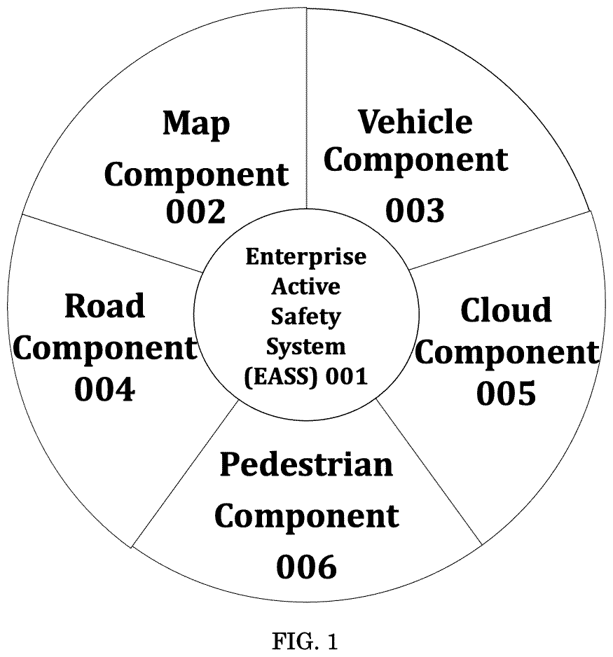

FIG. 1 shows the host components of the Enterprise Active Safety System (EASS) 001. The EASS can be hosted on one or more of five distinct components: a Map component 002, a Vehicle network component 003, an intelligent Road infrastructure component 004, a Cloud component 005, and a Pedestrian component 006.

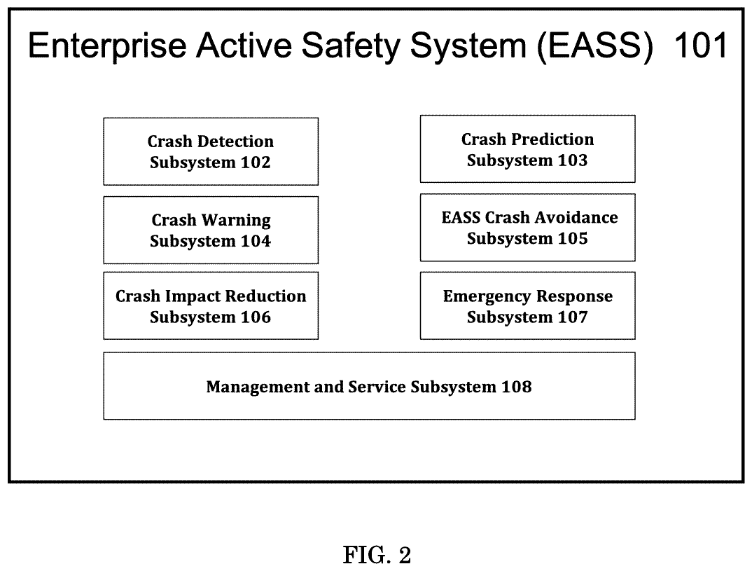

FIG. 2 shows an exemplary basic structure of an Enterprise Active Safety System (EASS). The EASS 101 comprises one or more of the following subsystems: a Crash Detection Subsystem 102, a Crash Prediction Subsystem 103, a Crash Warning Subsystem 104, an EASS Crash Avoidance Subsystem 105, a Crash Impact Reduction Subsystem 106, an Emergency Response Subsystem 107, and a Management and Service Subsystem 108.

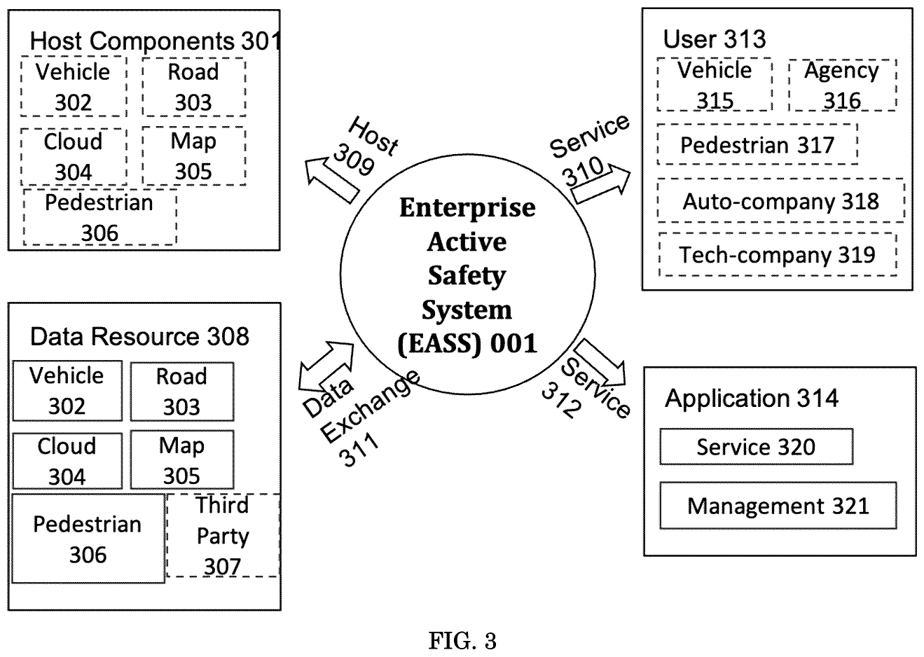

FIG. 3 shows the system structure of the EASS 001. The EASS 001 is hosted 309 on one or more of five distinct components: a vehicle component 302, a road component 303, a cloud component 304, a pedestrian component 306, and a map component 305. The EASS 001 provides service 310 to a user 313 which could be a vehicle 315, an agency 316, a pedestrian 317, an Auto-company 318, or a Tech-company 319. The EASS 001 also provides service to application 314, which could be a service application 320 or a management application 321. The EASS 001 has data exchange 311 with a data resource 308. The data resource 308 of EASS 001 includes data from vehicle 302, data from road 303, data from cloud 304, data from map 305, data from pedestrian 306, and/or data from third party 307.

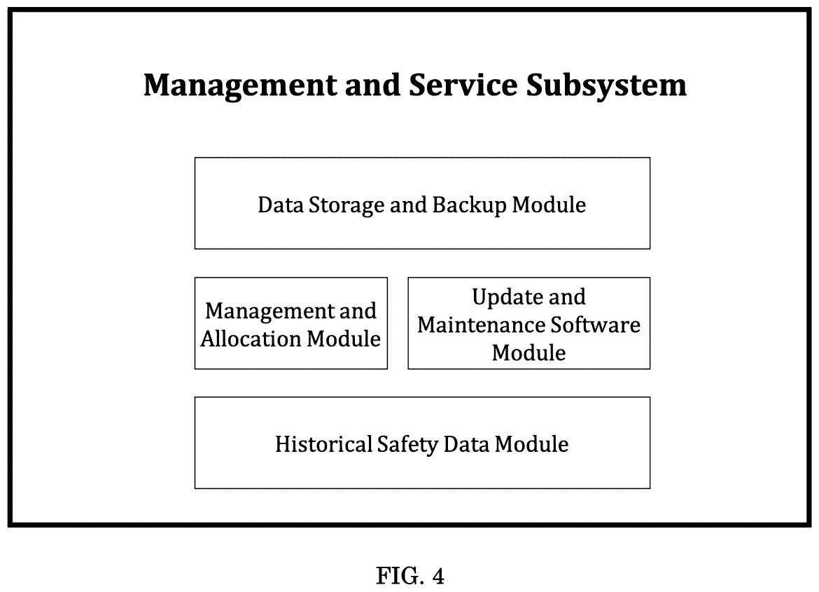

FIG. 4 shows an exemplary basic structure of the Management and Service Subsystem. The Management and Service Subsystem 401 comprises a Data Storage and Backup Module 402, a Management and Allocation Module 403, an Update and Maintenance Software Module 404, and a Historical Safety Data 405.

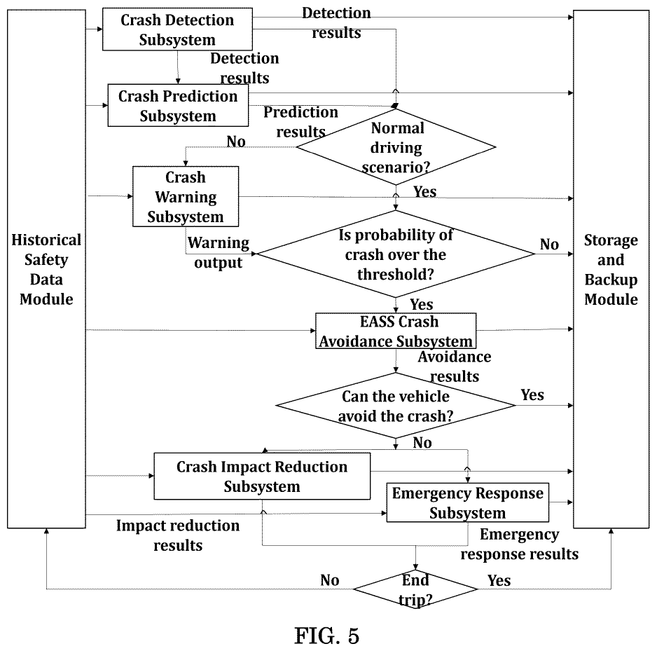

FIG. 5 shows the workflow of the Management and Service Subsystem. In some embodiments, the Management and Service Subsystem sends historical safety data from the Historical Safety Data Module to each subsystem, including the Crash Detection Subsystem, Crash Prediction Subsystem, Crash Warning Subsystem, Crash Avoidance Subsystem, Crash Impact Reduction Subsystem, and Emergency Response Subsystem. The Management and Service Subsystem manages the data flow between each subsystem. In some embodiments, the Crash Detection Subsystem receives historical safety data from the Historical Safety Data Module of the Management and Service Subsystem, and sends detection results to the Crash Prediction Subsystem and Storage and Backup Module. The Crash Prediction Subsystem receives detection results from the Crash Detection Subsystem. The prediction results, as the output of the Crash Prediction Subsystem, are sent to the Storage and Backup Module of the Management and Service Subsystem. The Management and Service Subsystem identifies whether the probability of crash is over the predetermined threshold or not. If yes, the Management and Service Subsystem sends detection results and prediction results to the Crash Avoidance Subsystem. At the same time, the Management and Service Subsystem identifies the driving scenario. If the driving scenario is not normal, the Management and Service Subsystem sends prediction results to the Crash Warning Subsystem. The warning results, as the output of the Crash Warning Subsystem, are sent to the Storage and Backup Module of the Management and Service Subsystem. If the driving scenario is normal, the Management and Service Subsystem identifies whether the crash probability is over the predetermined threshold. If the crash probability is over the threshold, the Management and Service Subsystem sends the detection and prediction results to the Crash Avoidance Subsystem. The avoidance results, as the output of the Crash Avoidance Subsystem, are sent to the Storage and Backup Module of the Management and Service Subsystem. The Management and Service Subsystem identifies whether the vehicle can avoid the crash. If the vehicle can avoid the crash, it sends the avoidance result to the Storage and Backup Module to store and backup. If the vehicle cannot avoid the crash, the Management and Service Subsystem sends avoidance results to the Crash Impact Reduction Subsystem and Emergency Response Subsystem. The impact reduction results and emergency response results, as the output of these two subsystems, are sent to the Storage and Backup Module of the Management and Service Subsystem. Subsequently, the Management and Service Subsystem identifies whether it is the end of the trip. If it is the end of the trip, the Management and Service Subsystem stores and backups trip information in the Storage and Backup Module of the Management and Service Subsystem. If it is not the end of the trip, the Management and Service Subsystem goes back to the Historical Safety Data Module and sends historical data to all subsystems. The data in the Historical Safety Data Module is updated by the Storage and Backup Module at each time step.

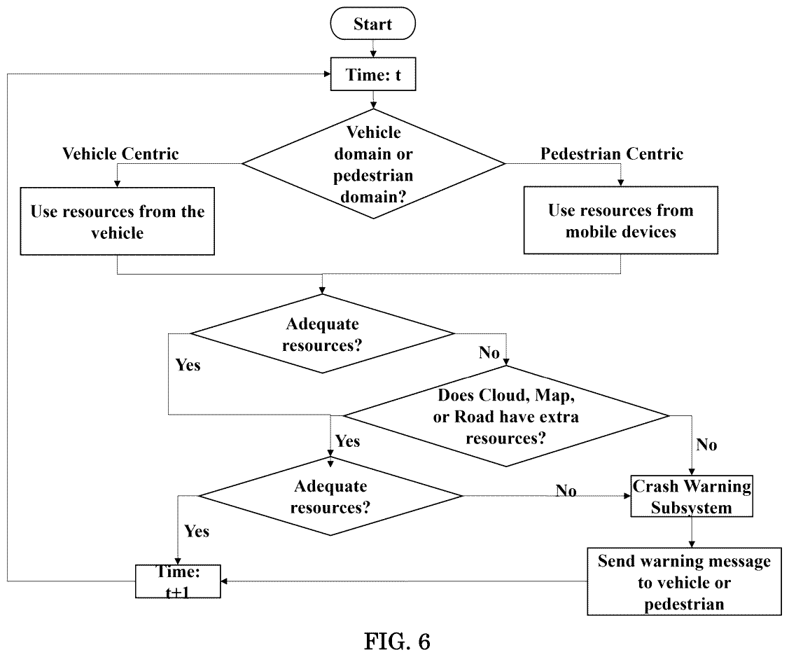

FIG. 6 shows the management and allocation process of the Management and Service Subsystem. In some embodiments, the subsystem determines whether the domain is vehicle or pedestrian. In the vehicle domain, the subsystem utilizes onboard resources of vehicles such as computing, storage, and resources. In the pedestrian domain, the subsystem uses resources (including computing, storage, and sensing) from a mobile device. If the resources are found to be sufficient, the process progresses to the next time point t+1. If the resources are inadequate, the system determines whether supplementary resources are available from the Cloud component, Map component, or Road component, and whether the extra resources are adequate. If the extra resources are adequate, the process progresses to the next time point t+1. For other situations (no extra resources or no adequate extra resources), a Crash Warning Subsystem sends a warning message to the vehicle or pedestrian, and then the process moves to the next time point t+1.

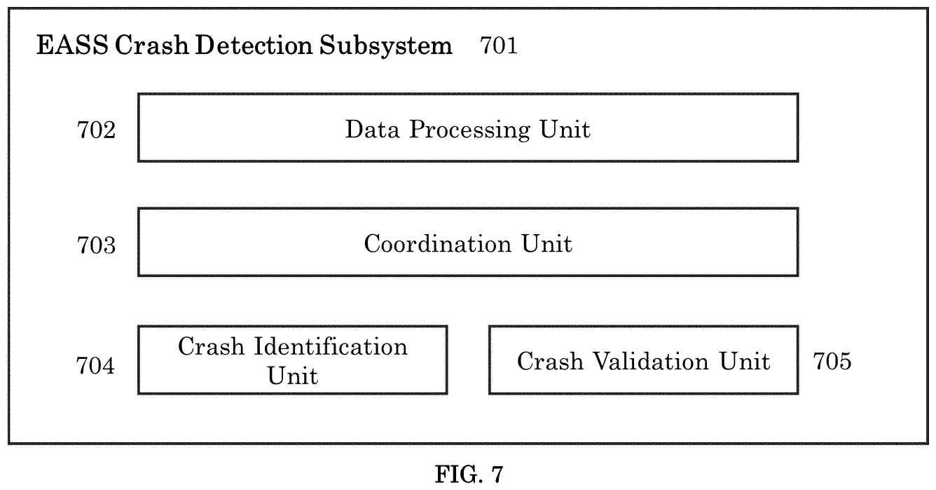

FIG. 7 shows an exemplary structure of the EASS Crash Detection Subsystem. The EASS Crash Detection Subsystem 701 comprises a Data Processing Unit 702, a Coordination Unit 703, a Crash Identification Unit 704, and a Crash Validation Unit 705.

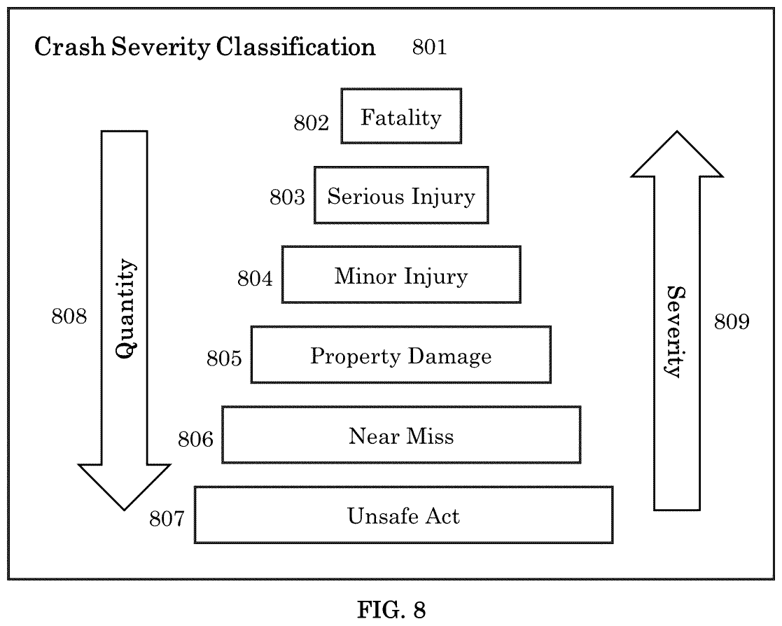

FIG. 8 shows the identified Crash Severity Classification 801 by the EASS Crash Detection Subsystem. Crashes are classified as Fatality 802, Serious Injury 803, Minor Injury 804, Property Damage 805, Near Miss 806, and Unsafe Act 807. The crash types with higher severity 809 are associated with lower quantity 808, and conversely, those with lower severity 809 are associated with higher quantity 808.

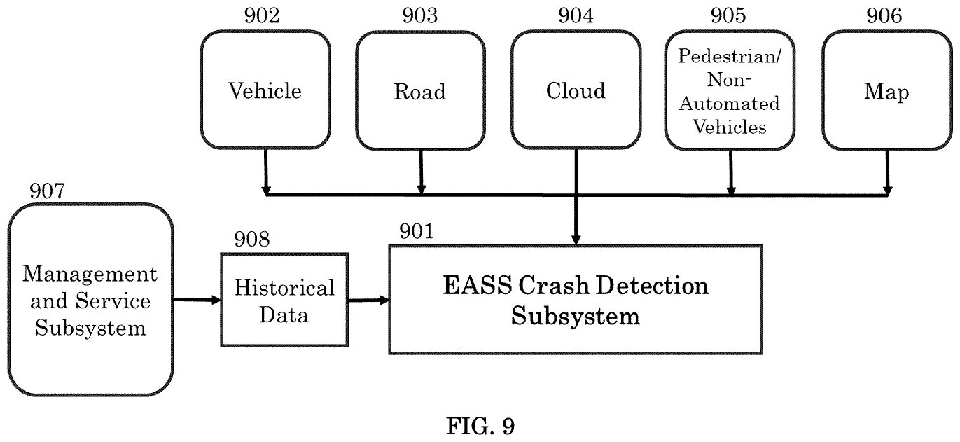

FIG. 9 shows that the input data of EASS Crash Detection Subsystem 901 comprises information from one or more of Vehicle 902, Road 903, Cloud 904, Pedestrian/Non-automated Vehicle 905, Map 906 and Historical Data 908 from EASS Crash Management and Service Subsystem 907.

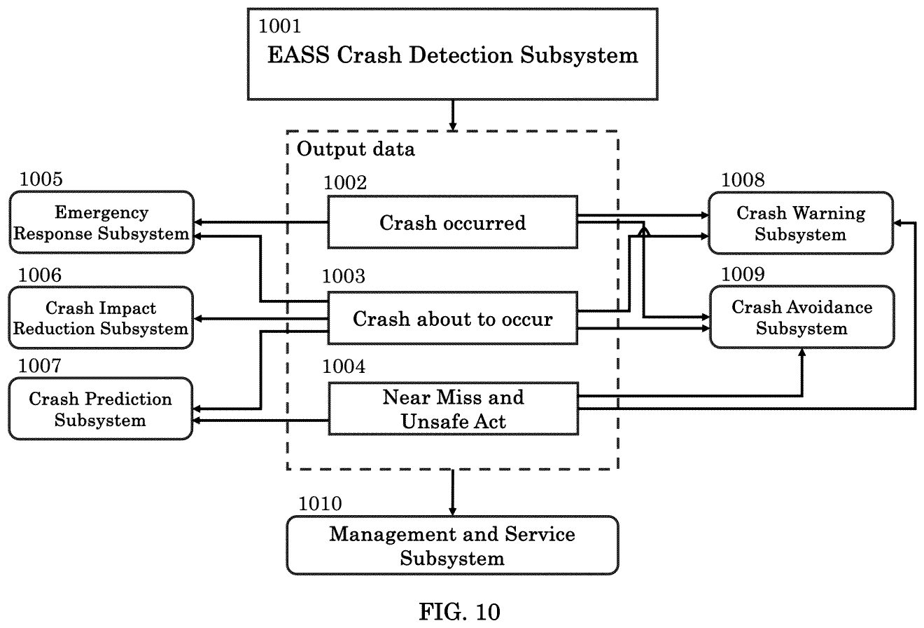

FIG. 10 shows that the output data of EASS Crash Detection Subsystem 1001 comprises one or more of the crash information: crash has occurred 1002, crash about to occur 1003, and near miss 1004. The Crash Detection Subsystem 1001 sends output data “crash has occurred” 1002 to one or more of Crash Warning Subsystem 1008, Crash Avoidance Subsystem 1009, Emergency Response Subsystem 1005 and Crash Management and Service Subsystem 1010. The Crash Detection Subsystem 1001 sends output data “crash about to occur” 1003 to one or more of Crash Prediction Subsystem 1007, Crash Warning Subsystem 1008, Crash Avoidance Subsystem 1009, Crash Impact Reduction Subsystem 1006, Emergency Response Subsystem 1005 and Crash Management and Service Subsystem 1010. The Crash Detection Subsystem 1001 sends output data “near miss” 1004 to one or more of Crash Prediction Subsystem 1007, Crash Warning Subsystem 1008, Crash Avoidance Subsystem 1009, and Crash Management and Service Subsystem 1010.

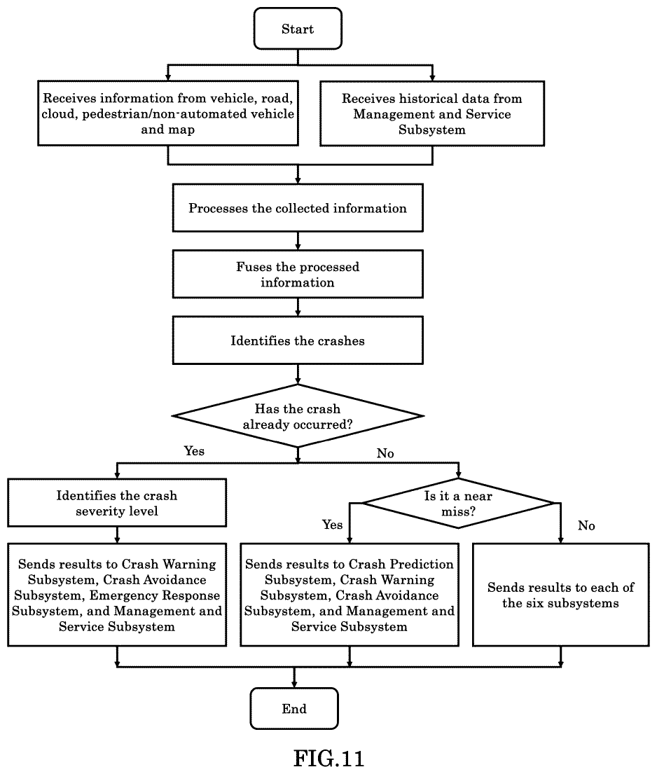

FIG. 11 shows the workflow of the EASS Crash Detection Subsystem. In some embodiment, the EASS Crash Detection Subsystem receives information from one or more of the vehicle component, road component, cloud component, pedestrian/non-automated vehicle component, and map component. It also receives historical data from the Management and Service Subsystem. Next, the Crash Detection Subsystem processes the collected information, fuses the processed information, and identifies the crashes. The Crash Detection Subsystem then determines whether a crash has already happened. If a crash has occurred, the subsystem identifies the severity level of the crash, and sends results to the Crash Warning Subsystem, Crash Avoidance Subsystem, Emergency Response Subsystem, and Crash Management and Service Subsystem. Otherwise, if the crash has not occurred, the Crash Detection Subsystem further determines whether it is a near miss. If the Crash Detection Subsystem identifies the near miss, it sends the detection results to the Crash Prediction Subsystem, Crash Warning Subsystem, Crash Avoidance Subsystem, and Management and Service Subsystem. Otherwise, if the Crash Detection Subsystem does not identify the near miss, it sends the detection results to all the other six subsystems.

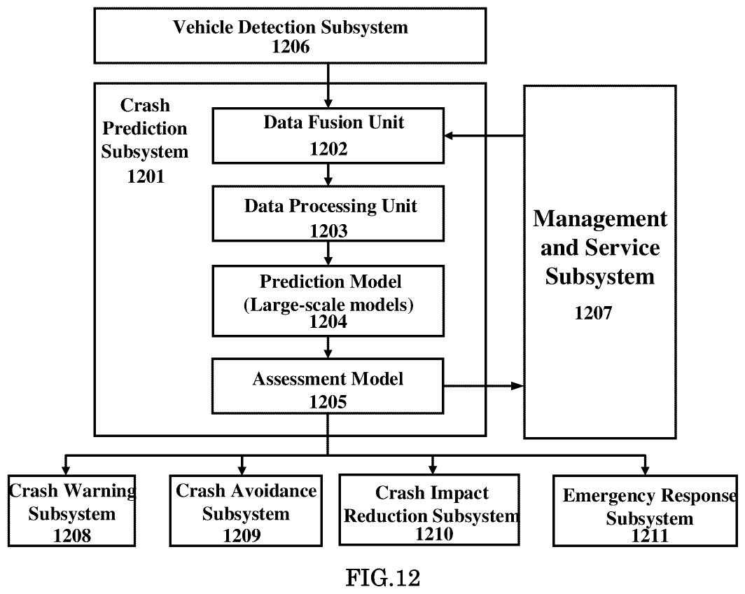

FIG. 12 shows an exemplary basic structure and data flow of the Crash Prediction Subsystem. The Crash Prediction Subsystem 1201 comprises a Data Fusion Unit 1202, a Data Processing Unit 1203, a Prediction Model 1204, and an Assessment Model 1205. The Crash Prediction Subsystem 1201 receives real-time and historical data from Vehicle Detection Subsystem 1206 and Management and Service Subsystem 1207, and generates prediction outcomes for Crash Warning Subsystem 1208, Crash Avoidance Subsystem 1209, Crash Impact Subsystem 1210, and Emergency Response Subsystem 1211.

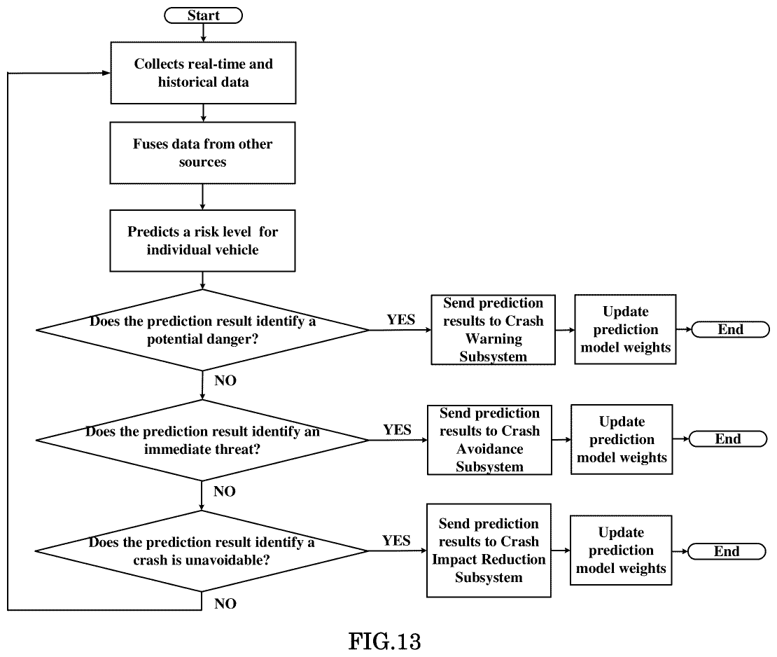

FIG. 13 shows a flowchart of the Crash Prediction Subsystem. The Crash Prediction Unit collects data from various sources, including vehicle detection data, vehicle status data, road detection data, cloud detection data, and historical data from the Management and Service Subsystem. Additionally, the Crash Prediction Unit integrates predicted data from the previous time step, sources from other surrounding vehicles, the road prediction unit, and the cloud prediction unit. This integrated data serves as the input for the vehicle prediction model. The vehicle prediction model generates a prediction for individual vehicles, producing a probability for each risk scenario and classifying the risk level. The risk assessment prediction result identifies potential risks in the upcoming segment, situations that might lead to a crash, or immediate threats. This allows for actions to be taken to prevent a crash or, in cases where a crash is imminent and unavoidable, to reduce the severity of the impact.

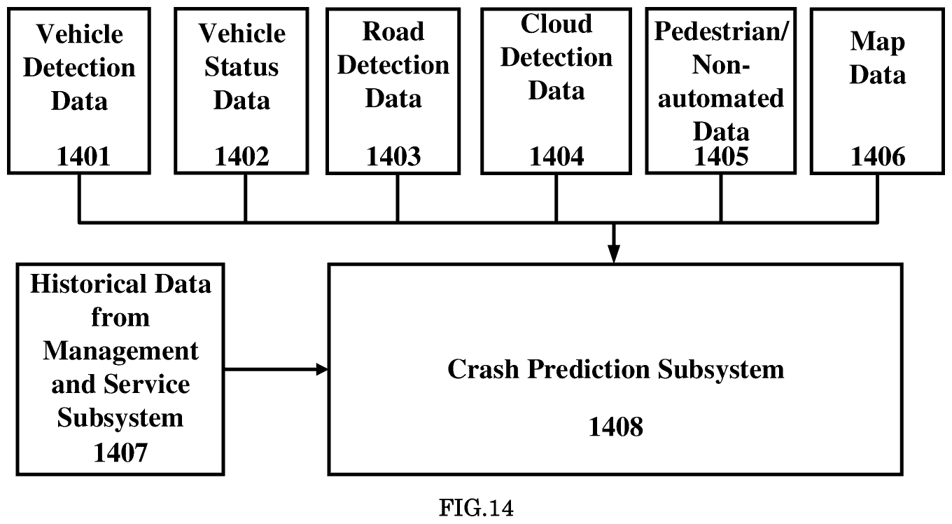

FIG. 14 shows exemplary input data of the Crash Prediction Subsystem. The Crash Prediction Subsystem 1408 receives and fuses vehicle detection data 1401, vehicle status data 1402, road detection data 1403, cloud detection data 1404, pedestrian/non-automated data 1405, map data 1406, and historical data from Management and Service Subsystem 1407.

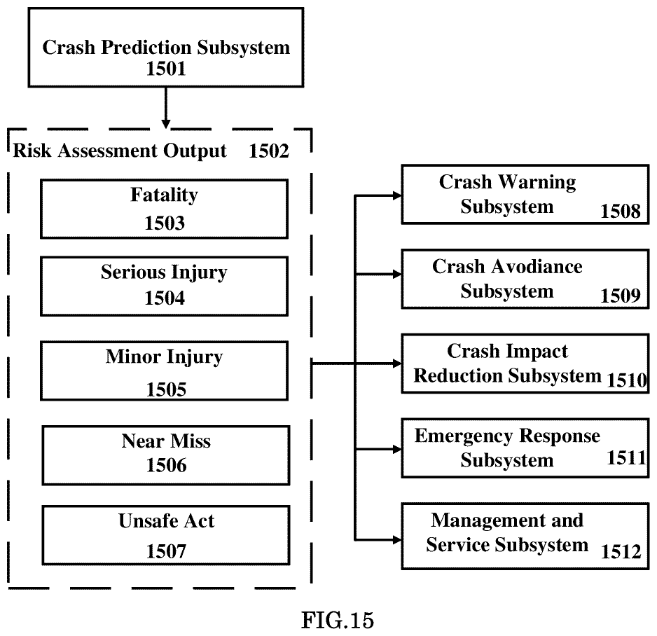

FIG. 15 shows exemplary output data of the Crash Prediction Subsystem. The Crash Prediction Subsystem 1501 generates a risk assessment output 1502 including Fatality 1503, Serious Injury 1504, Minor Injury 1505, Near Miss 1506, and Unsafe Act 1507 that are sent to the Management and Service Subsystem 1512 and one or more of the following subsystems: Crash Warning Subsystem 1508, Crash Avoidance Subsystem 1509, Crash Impact Reduction Subsystem 1510, and Emergency Response Subsystem 1511.

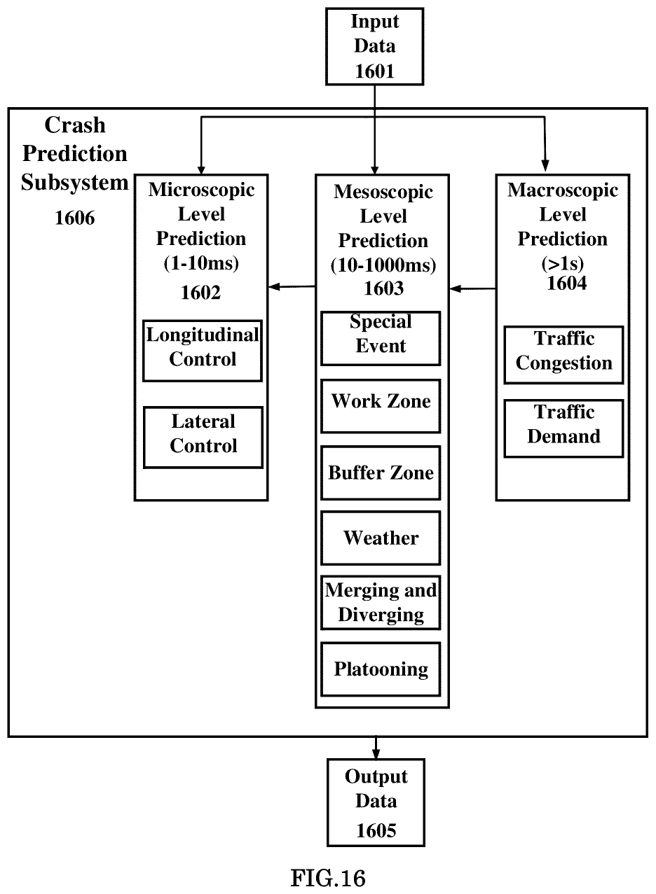

FIG. 16 shows the exemplary prediction level of the Crash Prediction Subsystem. The Crash Prediction Subsystem 1606 is configured to generate prediction data at Microscopic Level (1-10 milliseconds or less) 1602, Mesoscopic Level (10-1000 milliseconds) 1603, and Macroscopic Level (>1 second) 1604.

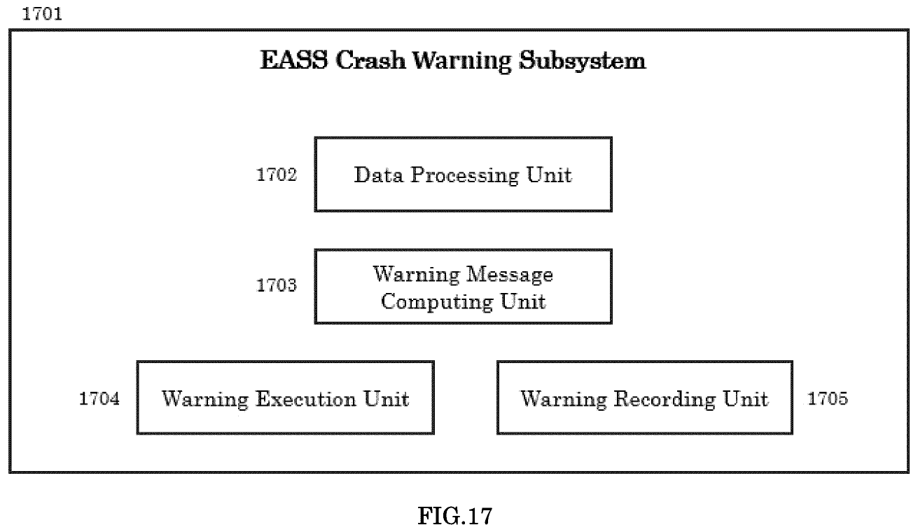

FIG. 17 shows an exemplary structure of EASS Crash Warning Subsystem. The EASS Crash Warning Subsystem 1701 comprises a Data Processing Unit 1702, a Warning Message Computing Unit 1703, a Warning Execution Unit 1704, and a Warning Fusion Unit 1705.

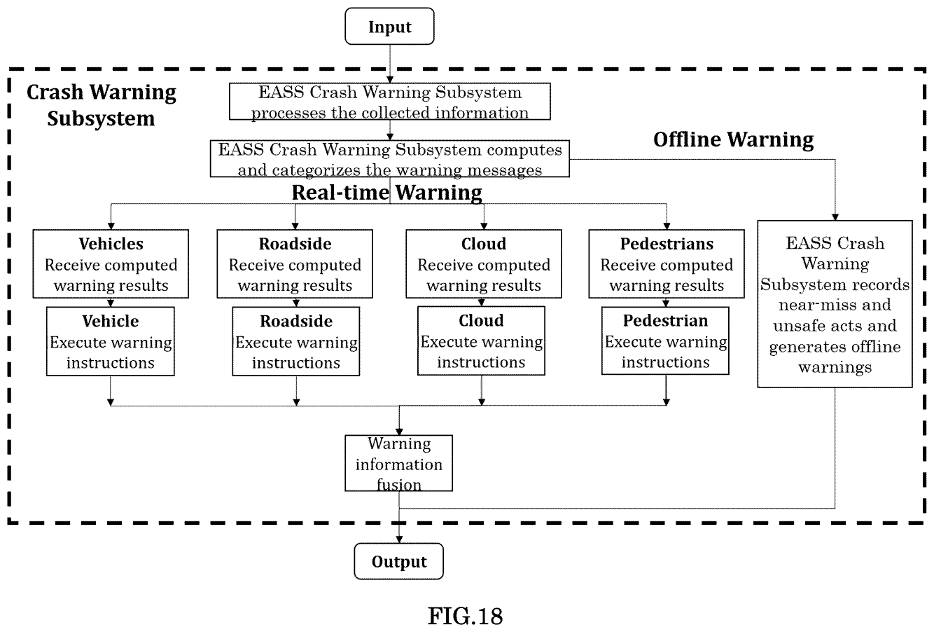

FIG. 18 shows that the process begins with the subsystem processing the collected information from input. The EASS Crash Warning Subsystem then computes and categorizes the warning messages into real-time and offline warnings. For real-time warnings, vehicles receive computed warning results through Onboard Units (OBUs), vehicle-based alarm systems, and electronic warning devices that may engage hearing, vision, or haptic feedback mechanisms. The Roadside units also receive computed warning results, likely through Roadside Units (RSUs) equipped with information boards that provide auditory and visual alerts. In the cloud, the computed warning results are received and can be displayed on cloud platforms and dashboards, again utilizing auditory and visual warnings. The Pedestrians receive computed warnings on their personal devices, such as phones, which could involve hearing, vision, or haptic feedback. For offline warnings, the warning subsystem records near-miss events and unsafe acts to generate offline warnings. The EASS Crash Warning Subsystem concludes with a fusion of warning information from all inputs leading to the output.

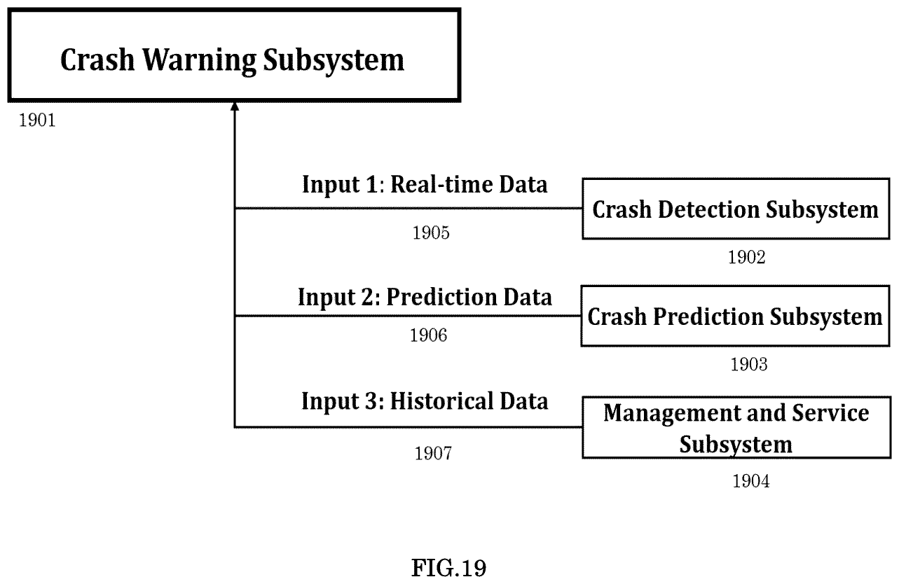

FIG. 19 shows the input data of the EASS Crash Warning Subsystem. The Crash Warning Subsystem 1901 receives Real-time Data 1905 from Crash Detection Subsystem 1902, receives Prediction Data 1906 from Crash Prediction Subsystem 1903, receives Historical Data 1907 from Management and Service Subsystem 1904.

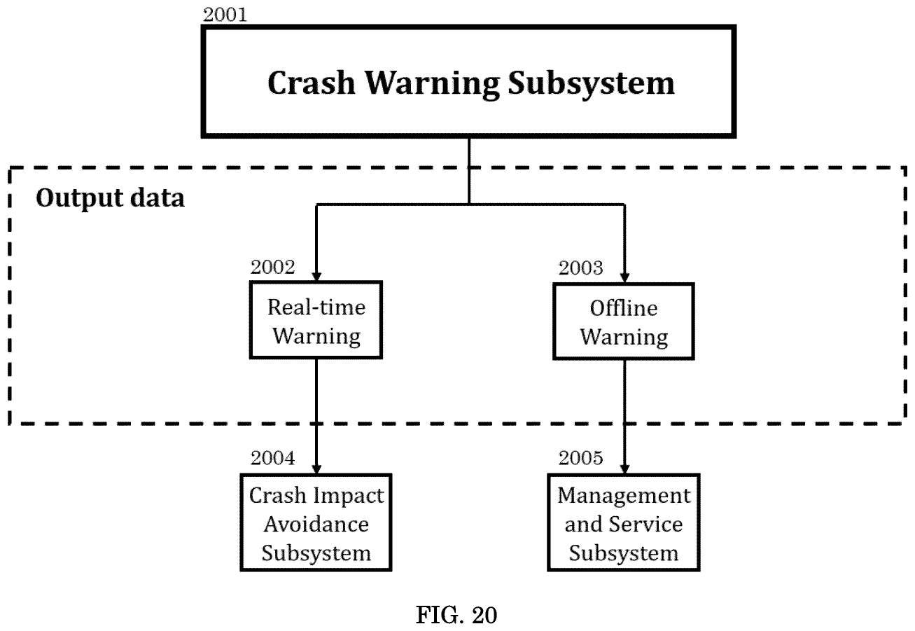

FIG. 20 shows the output data of EASS Crash Detection Subsystem 2001, which comprises one or more of the crash information: Real-time Warning 2002 and Offline Warning 2003. The Real-time Warning 2002 is sent to the Crash Avoidance Subsystem 2006, and the Offline Warning 2003 is sent to the Crash Management and Service Subsystem 2007.

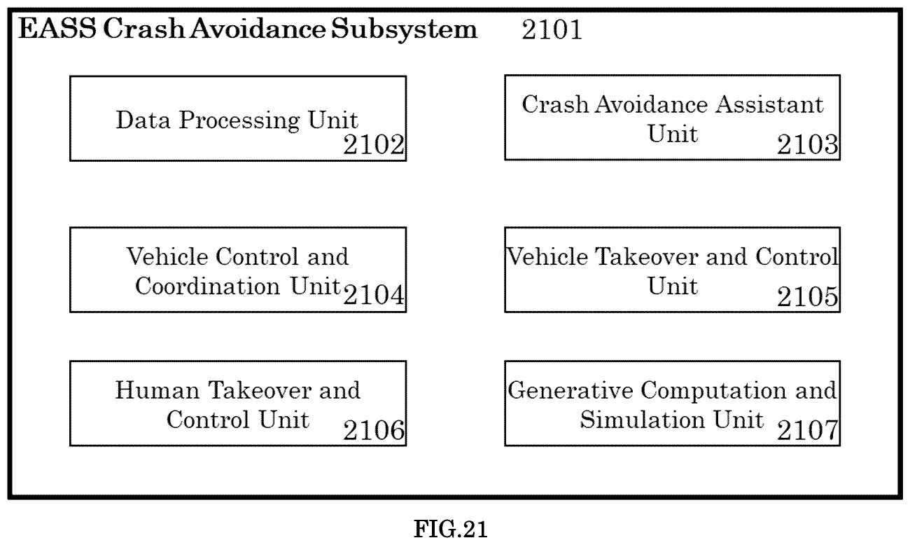

FIG. 21 shows an exemplary basic structure of the EASS Crash Avoidance Subsystem. The Crash Avoidance Subsystem 2101 comprises a Data Processing Unit 2102, a Crash Avoidance Assistant Unit 2103, a Vehicle Control and Coordination Unit 2104, a Vehicle Takeover and Control Unit 2105, a Human Takeover and Control Unit 2106, and a Generative Computation and Simulation Unit 2107.

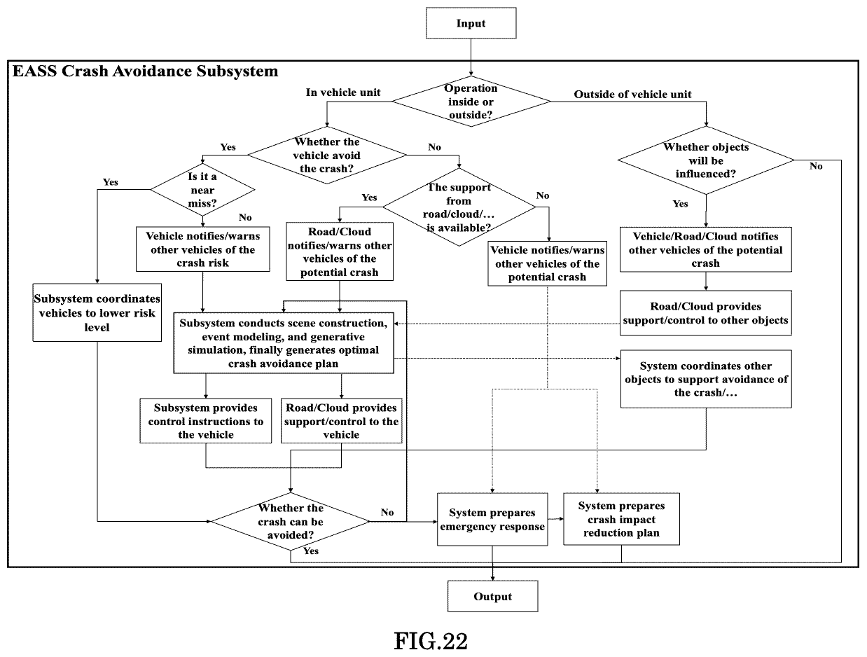

FIG. 22 shows the workflow of the EASS Crash Avoidance Subsystem. The EASS Crash Avoidance Subsystem receives input data and determines whether the operation is for in-vehicle unit or for outside of vehicle unit. If the operation is for in-vehicle unit, the subsystem will further determine whether the vehicle can avoid the crash. If the vehicle can avoid the crash, the vehicle notifies/warns other vehicles of the crash risk, and the subsystem provides control instructions to the vehicle. Otherwise, if the vehicle cannot avoid the crash, the subsystem further determines whether the support from the road component and/or cloud component is available. If available, the road component and/or cloud component notify other vehicles of the potential crash, and then provide support/control to the vehicle. Otherwise, the vehicle notifies/warns other vehicles of the potential crash. On the other hand, if the operation is for an outside vehicle unit, the subsystem determines whether objects outside the vehicle will be influenced. If the objects outside the vehicle are influenced, the Vehicle/Road/Cloud notifies/warns other vehicles of the potential crash. The Road/Cloud provides support/control to other objects. The subsystem coordinates other objects to support avoidance of the crash. Finally, the subsystem determines whether the crash can be successfully avoided. If the crash can be avoided, the subsystem sends successful avoidance results/near miss results to the Management and Service Subsystem. Otherwise, the subsystem prepares emergency responses and sends them to the Emergency Response Subsystem. It then prepares a crash impact reduction plan and sends to the Crash Impact Reduction Subsystem.

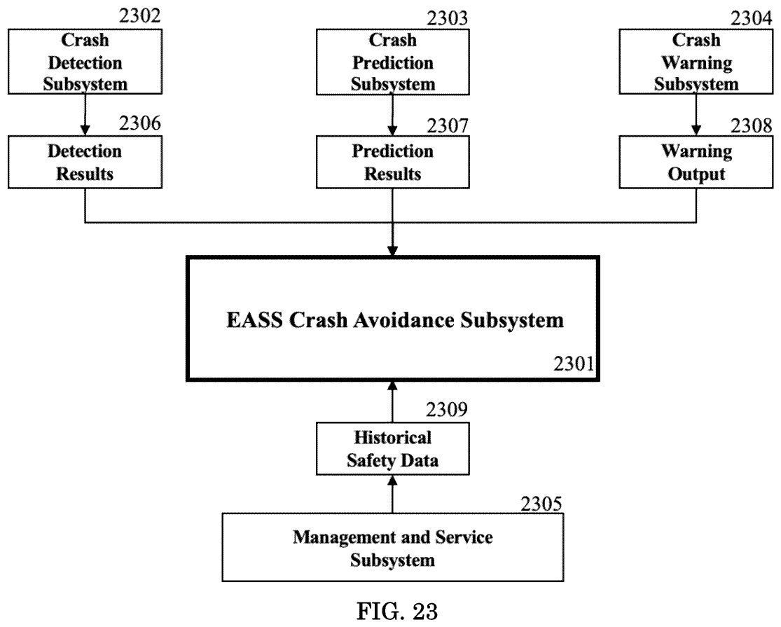

FIG. 23 shows the input data of the EASS Crash Avoidance Subsystem. The Crash Avoidance Subsystem 2301 receives detection results 2306 from Crash Detection Subsystem 2302, receives prediction results 2307 from Crash Prediction Subsystem 2303, receives warning output 2308 from Crash Warning Subsystem 2304, and receives historical safety data 2309 from Management and Service Subsystem 2305.

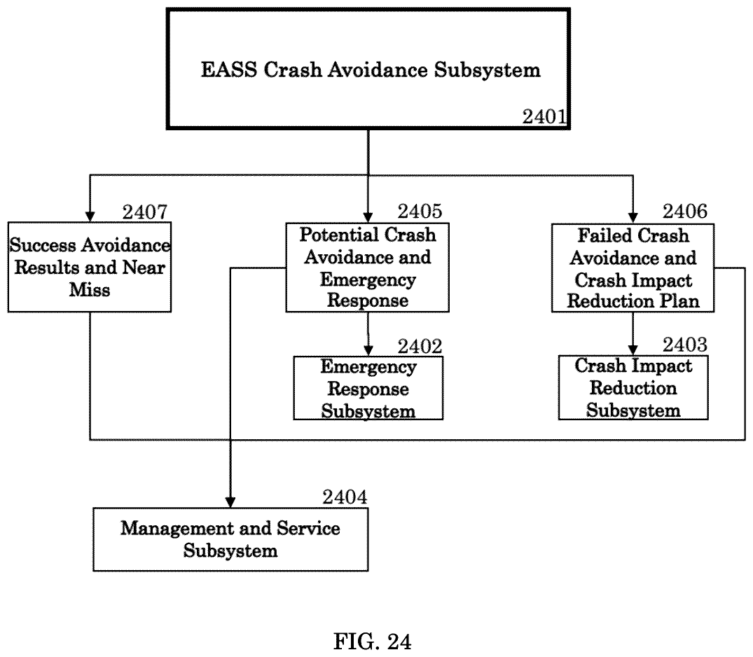

FIG. 24 shows the output data of the EASS Crash Avoidance Subsystem. The Crash Avoidance Subsystem 2401 sends potential crash avoidance and emergency response 2405 to Emergency Response Subsystem 2402, sends the failed crash avoidance and crash impact reduction plan 2406 to Crash Impact Reduction Subsystem 2403, and sends successful avoidance results and near miss results 2407 to Management and Service Subsystem 2404.

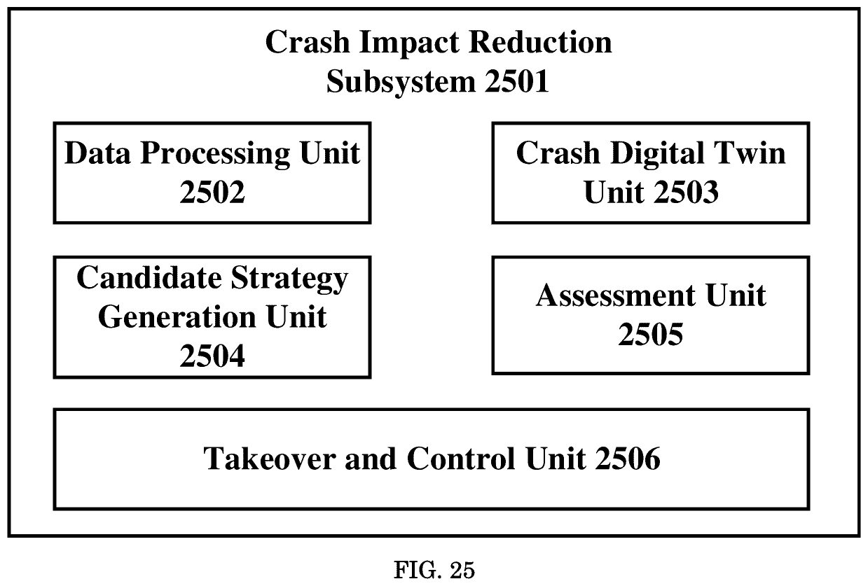

FIG. 25 shows the components of the Crash Impact Reduction Subsystem 2501. The Crash Impact Reduction Subsystem 2501 comprises of Data Processing Unit 2502, Crash Digital Twin Unit 2503, Candidate Strategy Generation Unit 2504, Assessment Unit 2505, and Takeover and Control Unit 2506.

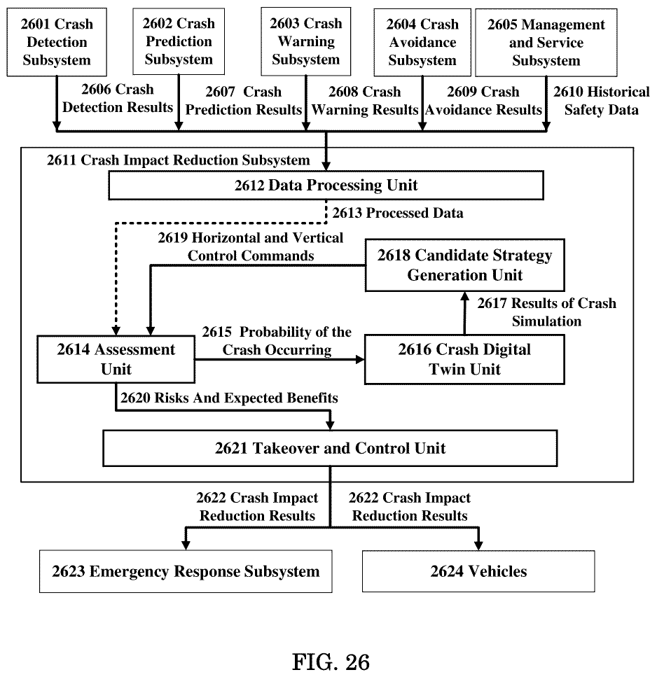

FIG. 26 shows the information flow of the Crash Impact Reduction Subsystem 2611. The data processing unit integrates crash detection results 2606 from the Crash Detection Subsystem 2601, crash prediction results 2607 from the Crash Prediction Subsystem 2602, crash warning results 2608 from Crash Warning Subsystem 2603, crash avoidance results 2609 from Crash Avoidance Subsystem 2604 and historical safety data 2610 from Management and Service Subsystem 2605 to provide comprehensive and up-to-date information to the Data Processing Unit 2612 of the Crash Impact Reduction Subsystem 2611. The Data Processing Unit 2612 sends the processed data 2613 to Assessment Unit 2614. The Assessment Unit 2614 sends the probability of the crash occurring 2615 to the Crash Digital Twin Unit 2616, and then the Crash Digital Twin Unit 2616 sends the results of crash simulation 2617 to Candidate Strategy Generation Unit 2618. The Candidate Strategy Generation Unit 2618 then sends horizontal and vertical control commands 2619 aimed at reducing crash impact to Assessment Unit 2614. The Assessment Unit 2614 sends the risks and expected benefits 2620 to the Takeover and Control Unit 2621. Finally, the Takeover and Control Unit 2621 sends crash impact reduction results 2622 to the EASS Emergency Response Subsystem 2623 and Vehicles 2624.

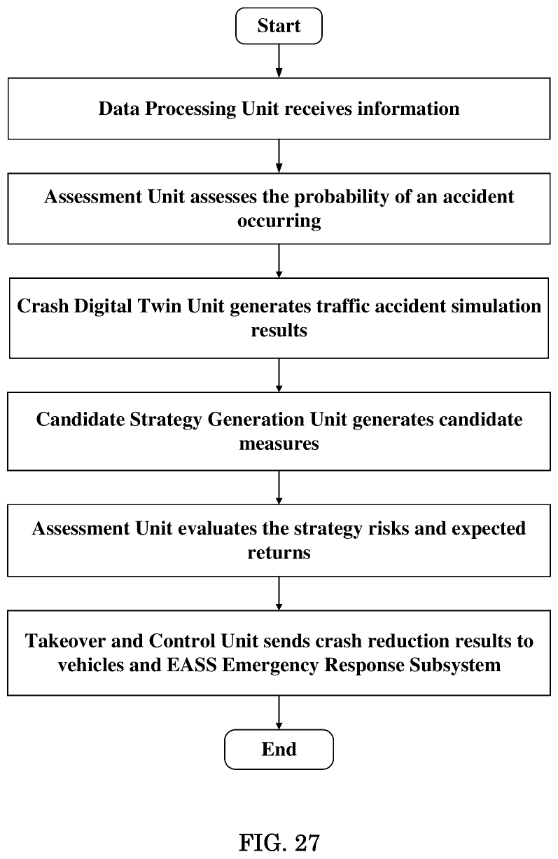

FIG. 27 shows the flowchart of the crash impact reduction method. The Data Processing Unit receives the crash detection results from the Crash Detection Subsystem, crash prediction results from the Crash Prediction Subsystem, crash warning results from the Crash Warning Subsystem, crash avoidance results from the Crash Avoidance Subsystem and historical safety data from the Management and Service Subsystem. The Assessment Unit then assesses the probability of the crash. Subsequently, the Crash Digital Twin Unit generates crash simulation results. The Candidate Strategy Generation Unit generates horizontal and vertical control commands and sends them to the Assessment Unit to evaluate the risks associated with each command and their expected benefits in terms of safety and overall system performance. Finally, the Takeover and Control Unit sends crash impact reduction results to vehicles and the Emergency Response Subsystem.

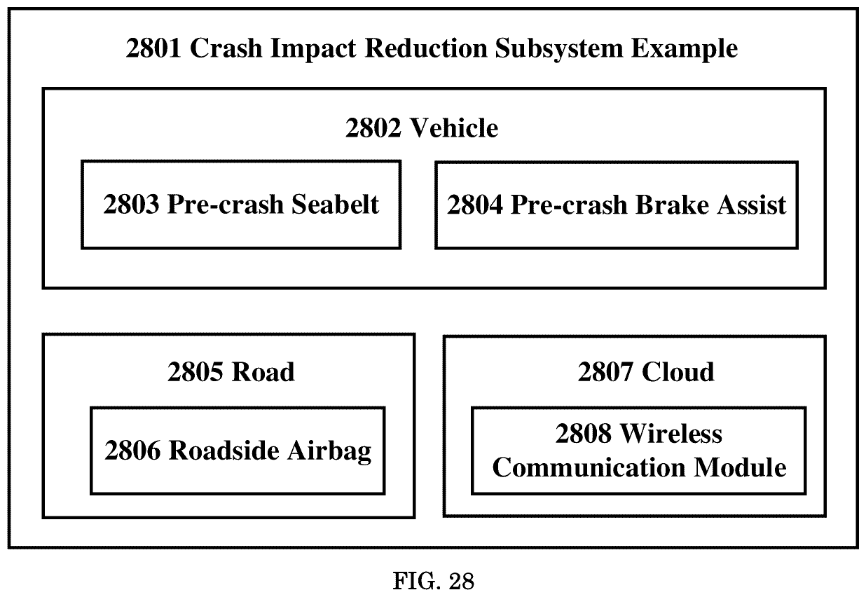

FIG. 28 shows the examples of Crash Impact Reduction Subsystem 2801, which include Vehicle 2802, Road 2805 and Cloud 2808. Examples of the Crash Impact Reduction Subsystem deployed on the Vehicle 2802 include the Pre-crash Seatbelt 2803 and Pre-crash Brake Assist 2804 (e.g, Toyota). The Pre-crash Seatbelt 2803 could reduce collision injury by eliminating seatbelt slack before the collision, restraining the driver/passenger at an earlier stage. When a collision is detected as inevitable, the Pre-crash Brake Assist 2804 is activated immediately, which will increase the braking force before the collision occurs, thereby reducing the collision speed. Examples of the Crash Impact Reduction Subsystem deployed on the Road 2805 include Roadside Airbag 2806, Sandbag, Guardrail. The Roadside Airbag 2806 would reduce the impact of the crash. It is designed to inflate extremely rapidly and then quickly deflate during a collision or impact, comprising of the airbag cushion, a flexible bag, an inflation module, and a controller module. The Roadside Airbag 2806 could provide the vehicle with soft cushioning during an unavoidable crash event to prevent or reduce any impact or impact caused injuries and loss for the vehicle occupant, travelers outside of the vehicle, the vehicle, and road infrastructure. Examples of the Crash Impact Reduction Subsystem deployed on the Road 2805 also include guiding the imminent crashing vehicle moving toward a sandbag or guardrail. Examples of the Crash Impact Reduction Subsystem deployed on the Cloud 2807 include Wireless Communication Module 2808. The Wireless Communication Module 2808 (e.g, OnStar) serves as part of the Crash Impact Reduction Subsystem to transmit vehicle system data to the service center in case of emergency. The Cloud 2807 could then calculate and determine the best crash strategy to reduce the crash impact, which is transmitted to the Vehicle 2802 and Road 2805 for execution.

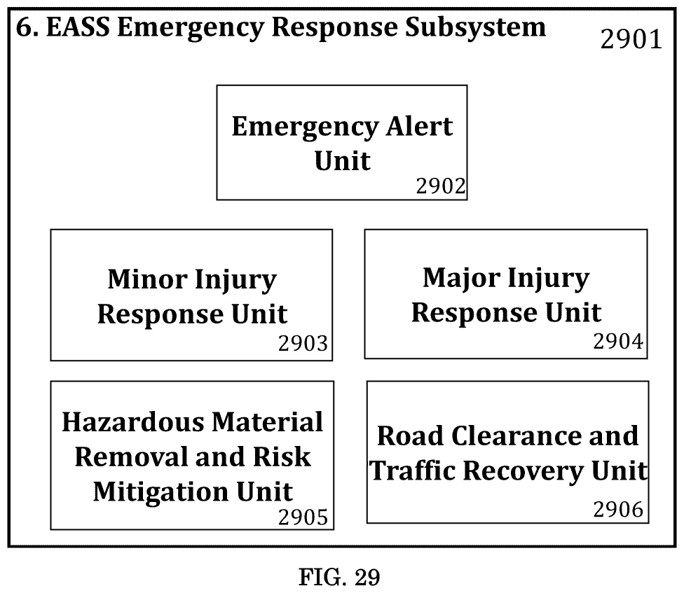

FIG. 29 shows the components of Emergency Response Subsystem 2901. The Emergency Response Subsystem 2901 comprises an Emergency Alert Unit 2902, a Minor Injury Response Unit 2903, a Major Injury Response Unit 2904, a Hazardous Material Removal and Risk Mitigation Unit 2905, and a Road Clearance and Traffic Recovery Unit 2906.

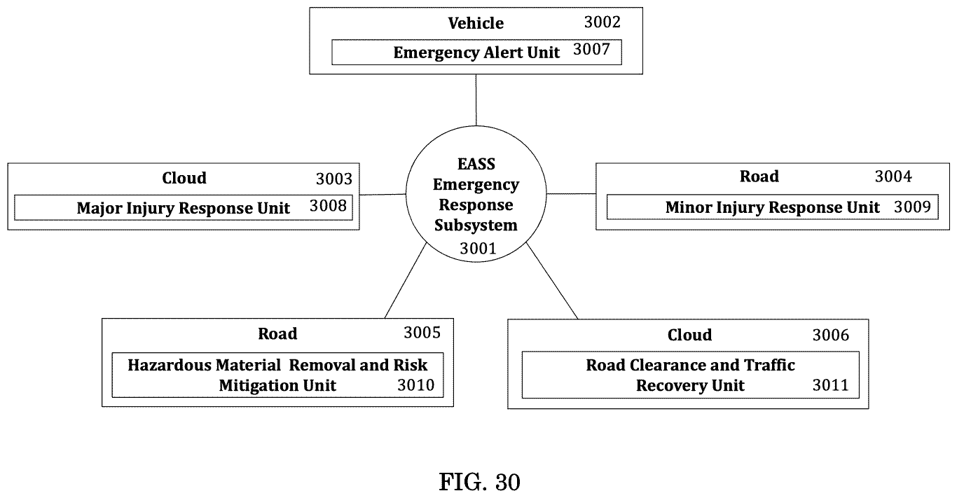

FIG. 30 shows the host of each unit of EASS Emergency Response Subsystem 3001. The Emergency Alert Unit 3007 is resided in Vehicle 3002. The Minor Injury Response Unit 3009 is resided in Road 3004. The Major Injury Response Unit 3008 is resided in Cloud 3003. The Hazardous Material Removal and Risk Mitigation Unit 3010 is resided in Road 3005. The Road Clearance and Traffic Recovery Unit 3011 is resided in Cloud 3006.

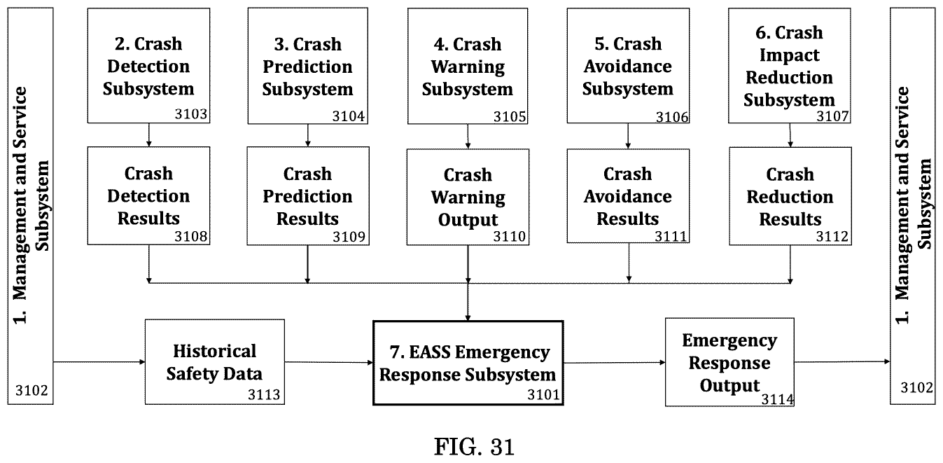

FIG. 31 shows the input and output of Emergency Response Subsystem 3101. The input data of Emergency Response Subsystem comprises the Crash Detection Results 3108 from Crash Detection Subsystem 3103, the Crash Prediction Results 3109 from Crash Prediction Subsystem 3104, the Crash Warning Output 3110 from Crash Warning Subsystem 3105, the Crash Avoidance Results 3111 from Crash Avoidance Subsystem 3106, the Crash Reduction Results 3112 from Crash Impact Reduction Subsystem 3107, and the Historical Safety Data 3113 from Management and Service Subsystem 3102. The output data comprises various Emergency Response Output 3114, which provides feedback to Management and Service Subsystem 3102.

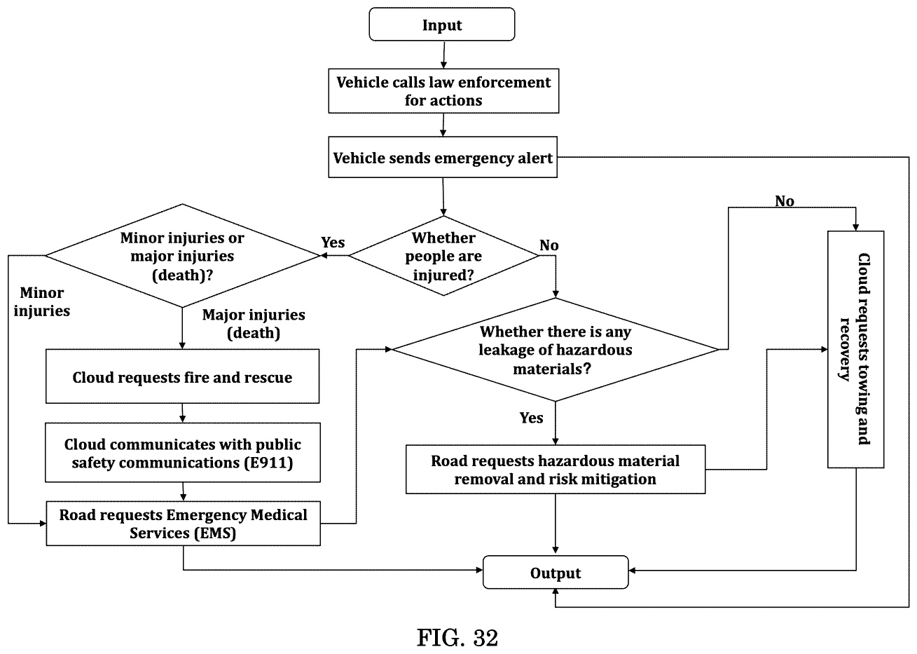

FIG. 32 shows the workflow of the Emergency Response Subsystem. While the emergency occurs with input data received, the Emergency Alert Unit resided in the Vehicle calls law enforcement for action and sends emergency alert to other vehicles at the same time immediately. If there are people injured, it determines whether there are minor or major injuries. If there are major injuries, the Major Injury Response Unit resided in the Cloud will immediately request fire and rescue, communicate with public safety communications (E911), and request Emergency Medical Services (EMS) to ensure people's safety. If there are minor injuries, the Minor Injury Response Unit resided in the Road will only need to request Emergency Medical Services (EMS) for medication and related services. Subsequently, if there happens to be a leakage of hazardous materials, the Hazardous Material Removal and Risk Mitigation Unit resided in the Road will first need to request hazardous material removal and risk mitigation. Otherwise, the Road Clearance and Traffic Recovery Unit resided in the Cloud will finally request towing and traffic recovery services.

### EMBODIMENTS

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre determined threshold; conversely, when an entity is said to be “absent”, it means the level or amount of this entity is below a pre-determined threshold. The pre determined threshold may be the threshold for detectability associated with the particular test used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, the term “number” shall mean one or an integer greater than one (e.g., a plurality).

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “Automated Driving System” (abbreviated “ADS”) refers to a system that performs driving tasks (e.g. lateral and longitudinal control of the vehicle) for a vehicle and thus allows a vehicle to drive with reduced human control of driving tasks and/or without human control of driving tasks.

As used herein, the term “Intelligent Driving” refers to a vehicular operational paradigm in which the vehicle assumes the role of a cognizant collaborator to the operator. Within this paradigm, the vehicle is equipped with an integrated network of image-capturing devices, sensory detectors, and computational regulators that cohesively function to discern potential hazards within the vehicular environment. The system is configured to proffer an assortment of notifications to the driver, which may manifest in visual, auditory, or tactile forms. The foundation of this system is predicated on the sophisticated synthesis of data procured from the cameras, sensors, and control units, ensuring an elevated echelon of vehicular safety and driver assistance.

As used herein, the term “Human Driving Vehicle” (abbreviated “HDV”) refers to any motorized vehicle primarily controlled by a human driver through manual inputs such as steering, braking, and acceleration. HDVs may include traditional combustion engine vehicles, electric vehicles, and hybrids that do not possess the capabilities to drive autonomously or semi-autonomously beyond basic driver assistance systems such as cruise control. These vehicles require direct and continuous input from a human operator to navigate and interact with the driving environment, notwithstanding the presence of supplementary systems designed to assist the driver in maintaining safety and comfort.

As used herein, the term “Operational Design Domain” (abbreviated “ODD”) refers to the operating conditions under which a given automated driving system and/or feature thereof is specifically designed to function, including, but not limited to, characteristics and/or restrictions related to environmental, geographical, and/or time-of-day factors, and/or related to the presence or absence of certain traffic or roadway characteristics. In some embodiments, the ODD is defined by SAE International Standard J3016, “Taxonomy and Definitions for Terms Related to Driving Automation Systems for On-Road Motor Vehicles” (J3016_201806), which is incorporated herein by reference.

As used herein, the term “Connected Automated Vehicle Highway System” (“CAVH System”) refers to a comprehensive system (e.g., an ADS) providing full vehicle operations and control for connected and automated vehicles (CAV), and, more particularly, to a system controlling CAVs by sending individual vehicles with detailed and time-sensitive control instructions for vehicle following, lane changing, route guidance, and related information. A CAVH system comprises sensing, communication, and control components connected through segments and nodes that manage an entire transportation system. CAVH systems comprise four control levels or components: vehicle; roadside unit (RSU), which, in some embodiments, is similar to or the same as a roadside intelligent unit (RIU); traffic control unit (TCU); and traffic control center (TCC). See U.S. Pat. Nos. 10,380,886; 10,867,512; and/or 10,692,365, each of which is incorporated herein by reference.

As used herein, the term “Intelligent Road Infrastructure System” (“IRIS”) refers to a system that facilitates vehicle operations and control for CAVH systems. See U.S. Pat. Nos. 10,867,512 and/or 10,692,365, each of which is incorporated herein by reference. In some embodiments, an IRIS further comprises a cloud component. In some embodiments, an IRIS provides transportation management and operations and individual vehicle control for connected and automated vehicles (CAV). For example, in some embodiments, an IRIS provides a system for controlling CAVs by sending individual vehicles with customized, detailed, and time-sensitive control instructions and traffic information for automated vehicle driving, such as vehicle following, lane changing, route guidance, and other related information.

As used herein, the term “Intelligence Allocation” refers to systems and methods that allocate, arrange, and distribute certain types of functions and intelligence, for connected automated vehicle highway (CAVH) systems, to facilitate vehicle operations and controls, to improve the general safety of the transportation system, and to ensure the efficiency, intelligence, reliability, and resilience of CAVH systems. The present invention also provides methods to define CAVH system intelligence and its levels, which are based on two dimensions: the vehicle intelligence and infrastructure intelligence. See U.S. Pat. No. 11,495,126, which is incorporated herein by reference.

As used herein, the term “event model” refers to any method, algorithm, framework or service that collects, processes, interprets, renders, decodes, encodes, fuses, predicts, determines, disperses, distributes, allocates, integrates, controls, manages, optimizes and providing information, intelligence and/or control instructions about an event that is affecting or will affect the operations of an automated driving system or any of its components. Examples of an event include, but not limited to, severe weather, work zone, poor lighting, porthole of pavement, slippery pavement, lane closures, traffic congestion, traffic control, restriction, emergency vehicles, sporting events, concerts, and traffic incidents.

As used herein, the term “GPS” refers to a global navigation satellite system (GNSS) that provides geolocation and time information to a receiver. Examples of a GNSS include, but are not limited to, the Global Positioning System developed by the United States, Differential Global Positioning System (DGPS), BeiDou Navigation Satellite System (BDS) System, GLONASS Global Navigation Satellite System), European Union Galileo positioning system, the NavIC system of India, and the Quasi-Zenith Satellite System (QZSS) of Japan.

As used herein, the term “vehicle” refers to any type of powered transportation device, which includes, and is not limited to, an automobile, truck, bus, motorcycle, or boat. The vehicle may normally be controlled by an operator or may be unmanned and remotely or autonomously operated in another fashion, such as using controls other than the steering wheel, gear shift, brake pedal, and accelerator pedal.

As used herein, the term “automated vehicle” or “autonomous vehicle” (abbreviated as “AV”) refers to an automated vehicle in an automated mode, e.g., at any level of automation (e.g., as defined by SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806), each of which is incorporated herein by reference)).

As used herein, the term “allocate”, “allocating”, and similar terms referring to resource distribution also include distributing, arranging, providing, managing, assigning, controlling, and/or coordinating resources.

As used herein, the term “resource” refers to computational capacity (e.g., computational power, computational cycles, etc.); memory and/or data storage capacity; sensing capacity; communications capacity (e.g., bandwidth, signal strength, signal fidelity, etc.); and/or electrical power.

As used herein, the term “service” refers to a process, a function that performs a process, and/or to a component or module that is configured to provide a function that performs a process.

As used herein, the term “safety” refers to the state or condition in which the risk of harm or damage is minimized for individuals and property within the vehicular environment. This encompasses the implementation of various technologies, practices, and strategies that collectively enhance the protection of vehicle occupants, pedestrians, and other road users.

As used herein, the term “safe system approach” refers to a holistic strategy adopted in traffic management and vehicular design that assumes human errors and acknowledges human vulnerabilities in all phases of mobility. This approach integrates roads, vehicles, speeds, and post-crash care to ensure that safety is maintained even when individual components fail. By focusing on redundancy and resilience, the safe system approach aims to prevent crashes and reduce the impact when crashes occur, ensuring that no loss of life or serious injury is acceptable within the system.

As used herein, the term “Active Safety” refers to the collective vehicle features and functionalities that actively prevent accidents and mitigate crash severity before an incident occurs. This encompasses a range of systems such as electronic stability control, anti-lock braking systems, and advanced driver assistance systems (ADAS) which include autonomous emergency braking, lane keeping assistance, and adaptive cruise control. Active safety systems are characterized by their dynamic nature, involving real-time data acquisition from vehicular sensors, and their subsequent immediate processing to enable proactive vehicular responses.

As used herein, the term “Passive Safety” refers to the vehicle systems designed to protect occupants during and after a crash event. This includes structural elements such as crumple zones, safety cells, and reinforcements that absorb and dissipate collision forces, as well as restraint systems like airbags and seat belts that minimize occupant movement and injury risk. Passive safety features are engaged during or after the point of impact and do not contribute to crash avoidance, but rather to the reduction of injury and maximization of occupant survival post-collision.

As used herein, the term “adapter” refers to an interface connecting two components, systems, subsystems, modules, etc. In some embodiments, an adapter provides communications between the two components, systems, subsystems, modules (e.g., for exchange of data, instructions, and/or information between the two components, systems, subsystems, modules). In some embodiments, an adapter provides a translation service for conversion of a first data format output by a first component, system, subsystem, or module into a second data format output for use by a second component, system, subsystem, or module. In some embodiments, an “adapter” defines the types of requests that can be made; the types of responses to requests that can be made; how requests and responses to requests are made; the data formats that are used for requests, responses to requests, and data exchange; and/or other conventions defining the interaction of two components, systems, subsystems, modules, etc.

As used herein, the term “connected vehicle” or “CV” refers to a connected vehicle, e.g., configured for any level of communication (e.g., V2V, V2I, and/or I2V).

As used herein, the term “connected autonomous vehicle” (or “connected automated vehicle”) or “CAV” refers to an autonomous vehicle that is able to communicate with other vehicles (e.g., by V2V communication), with roadside units (RSU) or roadside intelligent units (RIU), traffic control signals, and/or other infrastructure (e.g., an ADS or component thereof) or devices. That is, the term “connected autonomous vehicle” or “CAV” refers to a connected autonomous vehicle having any level of automation (e.g., as defined by SAE International Standard J3016 (2014)) and communication (e.g., V2V, V2I, and/or I2V).

As used herein, the term “data fusion” refers to integrating a plurality of data sources to provide information (e.g., fused data) that is more consistent, accurate, and useful than any individual data source of the plurality of data sources.

As used herein, the term “configured” refers to a component, module, system, subsystem, etc. (e.g., hardware and/or software) that is constructed and/or programmed to carry out the indicated function.

As used herein, the terms “determine,” “calculate,” “compute,” and variations thereof, are used interchangeably to any type of methodology, processes, mathematical operation, or technique.

As used herein, the term “reliability” refers to a measure (e.g., a statistical measure) of the performance of a system without failure and/or error. In some embodiments, reliability is a measure of the length of time and/or number of functional cycles a system performs without a failure and/or error.

As used herein, the term “artificial intelligence model” (or “AI model”) refers to a program that has been trained on a set of data to recognize certain patterns or make certain decisions without further human intervention. AI models apply different algorithms to relevant data inputs to achieve the tasks, or output, they've been programmed for. AI model is defined by its ability to autonomously make decisions or predictions, rather than simulate human intelligence. In some embodiments, the AI models comprise machine learning models and learning-based models.

As used herein, the term “Foundation Model” refers to a classification of deep learning neural network architectures which are trained upon expansive datasets to serve as a primary, versatile framework for further AI applications. These Foundation Models are distinguished by their extensive training on a vast and generalized corpus of data, which may be unstructured and unlabeled, enabling the model to execute a broad array of tasks. The utility of FMs lies in their ability to function as a baseline from which specialized machine learning (ML) models can be derived with increased efficiency and reduced development costs. Foundation Models are capable of processing and understanding multiple forms of input, including but not limited to natural language text, image data, and conversational dialects, thereby facilitating their application across a wide spectrum of AI-driven functionalities.

As used herein, the term “Localized AI” refers to a subset of artificial intelligence systems that are specifically designed and deployed to operate within a localized environment, such as an autonomous vehicle (AV), roadside infrastructure, roadside units (RSUs), cloud, edge cloud, traffic control unit (TCU), and/or traffic control center (TCC). Localized AI is characterized by its capacity to process and utilize local knowledge, information, data, and models that are sourced from one or more of nearby vehicles, roadside units (RSUs), edge cloud, centralized cloud infrastructure, traffic control unit (TCU), and/or traffic control center (TCC). The localized AI system is configured with a computational component that enables comprehensive functionalities including sensing the local environment, predicting behaviors of surrounding entities, making autonomous decisions, and controlling the vehicle in response to dynamic local conditions. Additionally, the local AI is capable of self-evolution and enhancement through heuristic learning and model training, which are informed by data inputs received from local traffic control centers or units (TCC/TCU) and integrated cloud resources. See U.S. Pat. No. 12,002,361; and/or U.S. patent application Ser. No. 18/672,739, each of which is incorporated herein by reference.

As used herein, the term “computing platform” refers to an integrated system of hardware and software components that provides the necessary computational capabilities to develop, train, deploy, and manage AI models. This platform may consist of specialized processors such as GPUs (Graphics Processing Units), TPUs (Tensor Processing Units), and high-performance CPUs (Central Processing Units), alongside the requisite memory, storage, and networking infrastructure. The computing platform may be configured to operate in various environments, including but not limited to, cloud-based services, distributed computing systems, edge computing nodes, and standalone workstations.

As used herein, the term “cloud” within the context of a Connected Automated Vehicle Highway (CAVH) system refers to a structured, tiered architecture composed of edge, regional, and central clouds. Each level is designed to fulfill specific roles tailored to the operational demands of the CAVH system. The edge cloud or edge computing node (abbreviated as “edge”) operates at the closest proximity to vehicular and roadside units, facilitating real-time data processing and immediate decision-making for individual vehicles and local infrastructure. The regional cloud provides intermediate-level data integration and analytics, focusing on broader area traffic management and coordination between multiple edge clouds to optimize regional traffic flows and infrastructure usage. Finally, the central cloud oversees overarching functions such as high-level traffic planning, large-scale data analytics, and overall system control, integrating inputs from the regional clouds to enhance the efficiency and safety of the entire transportation network. See U.S. Pat. No. 12,057,011; and/or U.S. patent application Ser. No. 17/779,372, each of which is incorporated herein by reference.

As used herein, the term “Collaborative Automated Driving System” or “CADS” refers to the technology which provides improved CAVH technologies (e.g., CAVH systems, components of CAVH systems, CAVH methods, and related CAVH functionalities) by enhancing the CAVH subsystem design scheme and adding further subsystems and algorithms to the CAVH technology. The CADS comprises: 1) a cooperative management subsystem; 2) a road subsystem; 3) a vehicle subsystem; 4) a communication subsystem; 5) a user subsystem; and/or 6) a supporting subsystem. Importantly, embodiments of the CADS technology described herein provide a comprehensive solution for implementing CAVH technologies more efficiently in a broad variety of different operational design domains using a system-level binding method. In some embodiments, the CADS optionally comprises a cloud subsystem and/or a map subsystem. In some embodiments, the CADS is configured to provide transportation management. In some embodiments, the CADS is configured to provide full vehicle operations and control for connected automated vehicle and highway systems by sending individual vehicles with detailed and time-sensitive control instructions for vehicle operations. See U.S. patent application Ser. No. 17/667,683, which is incorporated herein by reference.

As used herein, the term “support” when used in reference to one or more components of an ADS, CAVH, CADS, CAV, and/or a vehicle providing support to and/or supporting one or more other components of the ADS, CAVH, CADS, CAV, AV, CV, HDV, and/or a vehicle refers to, e.g., exchange of information and/or data between components and/or levels of the ADS, CAVH, CADS, CAV, and/or a vehicles; sending and/or receiving instructions between components and/or levels of the ADS, CAVH, CADS, CAV, and/or a vehicle; and/or other interaction between components and/or levels of the ADS, CAVH, CADS, CAV, and/or a vehicle that provide functions such as information exchange, data transfer, messaging, and/or alerting.

As used herein, the term “On-board Unit” (“OBU”) refers to a vehicle on-board device configured to provide transportation management and operations and vehicle control for CAV in coordination with an IRIS or CAVH, and, more particularly, to a system for controlling CAVs by sending customized, detailed, and time-sensitive control instructions and traffic information for automated vehicle driving to individual vehicles, such as vehicle following, lane changing, route guidance, and other related information. See U.S. patent application Ser. No. 16/505,034, which is incorporated herein by reference.

As used herein, the term “Vehicle Intelligent Unit” (“VIU”) refers to an interface configured to provide vehicle operations and control for CAV and, more particularly, to an interface configured to connect with a Collaborative Automated Driving System (CADS) and manage and/or control information exchange between CAV and CADS and manage and/or control CAV lateral and longitudinal movements, including vehicle following, lane changing, and route guidance. See U.S. patent application Ser. No. 17/718,443, which is incorporated herein by reference.

As used herein, the term “Roadside Intelligent Unit” (abbreviated “RIU”) may refer to one RIU, a plurality of RIU, and/or a network of RIU.

As used herein, the term “Intelligent Roadside Toolbox” (“IRT”) refers to a system that facilitates vehicle operations and control for a distributed driving system (DDS), which is a type of IRIS technology or CAVH technology. In some embodiments, the IRT provides modular access to CAVH and IRIS technologies (e.g., services) according to the automated driving needs of a particular vehicle. See U.S. patent application Ser. Nos. 17/192,529 and 16/996,684, each of which is incorporated herein by reference. In some embodiments, the IRT provides vehicles with individually customized information and real-time control instructions for the vehicle to perform driving tasks, e.g., vehicle following, lane changing, and/or route guidance.

As used herein, the term “road system” or “road” or “roadside system” refers to roads and to road infrastructure, e.g., intelligent road infrastructure (e.g., IRIS, IRT, RIU/RSU), road signs, road markings, traffic control devices (e.g., traffic signal controller); and/or conventional traffic operations centers.

As used herein, the term “ADS component” or “component of an ADS” refers individually and/or collectively to one or more of components of an ADS and/or a CAVH system, e.g., an OBU, VIU, RSU, RIU, TCC, TCU, TCC/TCU, TOC, CAV, a supporting subsystem, and/or a cloud component.

As used herein, the term “Cooperative Driving Automation” (abbreviated as “CDA”) refers to technology that supports and enables automated vehicles to cooperate through communication between vehicles, infrastructure devices capable of communication, and road users, such as pedestrians, bicyclists, and scooters. The CDA is defined in SAE International Standard J3216_202005, “Taxonomy and Definitions for Terms Related to Cooperative Driving Automation for On-Road Motor Vehicles” (published in 2020 (J3216_202005), which is incorporated herein by reference). The cooperation supports or enables performance of the dynamic driving task (DDT) for a subject vehicle with driving automation feature(s) engaged. Other participants may include other vehicles with driving automation feature(s) engaged, shared road users (e.g., drivers of manually operated vehicles or pedestrians or cyclists carrying personal devices), or road operators (e.g., those who maintain or operate traffic signals or workzones). CDA is defined in J3216 as having four classes of cooperation, A through D, with an increasing amount of cooperation associated with each successive class:
1. Class A: Status-sharing.
2. Class B: Intent-sharing.
3. Class C: Agreement-seeking.
4. Class D: Prescriptive.

Information shared among CDA participants can directly influence the dynamic driving task (DDT) by one or more nearby vehicles with driving automation feature(s) engaged. Ultimately, CDA-enabled cooperation can facilitate the safer and more efficient movement of road users, which can significantly improve the overall performance of the transportation system—and at lower cost than traditional methods. The CAVH or CADS are advanced versions of CDA.

As used herein, the term “CDA component” or “component of an CDA” refers individually and/or collectively to one or more of components of an CDA and/or a CAVH system, e.g., a AV, CAV, OBU, VIU, RSU, RIU, TCC, TCU, TCU, TOC, a supporting subsystem, and/or a cloud component.

As used herein, the term “Event” refers to any observable occurrence within a vehicular environment that is recognized by sensors or reported by users. This encompasses a wide range of happenings, from changes in traffic patterns to environmental conditions that could potentially affect vehicular operation or safety. An event may not necessarily lead to an adverse outcome but is indicative of the dynamic nature of the driving ecosystem, warranting monitoring and potential response.

As used herein, the term “Incident” refers to a specific event that disrupts the standard flow of traffic and may pose a risk to vehicle operation, property, or personal safety. Incidents include, but are not limited to, mechanical failures, emergency vehicle deployments, hazardous road conditions, or unauthorized pedestrian presence on the roadway. Incidents carry a greater implication of requiring intervention and may escalate to a “Crash” if not appropriately managed.

As used herein, the term “Crash” refers to an event where a vehicle collides with another vehicle, pedestrian, animal, road debris, or any other stationary obstruction such as a tree or utility pole. It is a type of road traffic incident that usually involves some degree of injury or property damage. A crash represents the culmination of events and incidents that have led to a significant and often detrimental impact, necessitating immediate and substantial response measures.

As used herein, the term “Fatality Crash” refers to crashes that result in one or more deaths. Fatalities are the most severe outcome of a crash and include any death that occurs within a certain time frame from the incident.

As used herein, the term “Serious Injury Crash” refers to crashes that require hospitalization and are life-threatening or result in permanent disability.

As used herein, the term “Minor Injury Crash” refers to crashes that produce any physical harm to an individual that does not require hospitalization and is not life-threatening.

As used herein, the term “Property Damage Crash” refers to crashes that result in damage to vehicles or other property without causing any injuries. Property damage can range from minor (such as scratches and dents) to major (such as the total loss of a vehicle).

As used herein, the term “Near Miss” refers to an event that, under slightly different circumstances, could have resulted in a crash. This includes situations where a collision is narrowly avoided and serves as a warning or indicator of potential risk factors that could lead to an actual crash.

As used herein, the term “Unsafe Act” refers to any behavior by drivers, pedestrians, or other road users that could contribute to a crash. This includes violations of traffic laws, distracted driving, impairment due to alcohol or drugs, and other reckless behaviors.

As used herein, the term “Crash Avoidance” refers to proactive safety mechanisms and interventions specifically designed and implemented to prevent the occurrence of a vehicular crash. These mechanisms may include a variety of active safety features such as automatic emergency braking, electronic stability control, and advanced driver assistance systems (ADAS) that utilize real-time sensor data to identify potential hazards and execute preemptive maneuvers to evade imminent collisions, thereby averting crashes.

As used herein, the term “Crash Warning” refers to systems and protocols established to alert drivers and other road users of the risk or potential of a crash scenario. This includes the dissemination of visual, auditory, or haptic signals that inform the driver of imminent dangers, such as obstacles in the vehicle's path, sudden traffic changes, or hazardous weather conditions, allowing for human or automated corrective action to be taken to mitigate the risk of a crash.

As used herein, the term “Crash Impact Reduction” refers to a range of passive safety features and post-crash active responses that aim to minimize the adverse effects associated with vehicular crashes. This encompasses structural vehicle design elements like crumple zones and side-impact beams, restraint systems such as airbags and seatbelts, and post-collision safety measures such as automatic notification of emergency services. These elements are intended to reduce the severity of injuries to occupants and damage to the vehicle in the event of a crash.

As used herein, the term “critical point” refers to a portion or region of a road that is identified as appropriate to be provided embodiments of the function allocation technology provided herein. In some embodiments, a critical point is categorized as a “static critical point” and in some embodiments, a critical point is categorized as a “dynamic critical point”. As used herein, a “static critical point” is a point (e.g., region or location) of a road that is a critical point based on identification of road and/or traffic conditions that are generally constant or that change very slowly (e.g., on a time scale longer than a day, a week, or a month) or only by planned reconstruction of infrastructure. As used herein, a “dynamic critical point” is a point (e.g., region or location) of a road that is a critical point based on identification of road conditions that change (e.g., predictably or not predictably) with time (e.g., on a time scale of an hour, a day, a week, or a month). Critical points based on historical crash data, traffic signs, traffic signals, traffic capacity, and road geometry are exemplary static critical points. Critical points based on traffic oscillations, real-time traffic management, or real-time traffic incidents are exemplary dynamic critical points.

In some embodiments, critical points are identified using, e.g., historical crash data (e.g., the top 20% (e.g., top 15-25% (e.g., top 15, 16, 17, 18, 19, 20, 21, 22, 23, 24, or 25%)) most frequent crash points in a road system are identified as critical points); traffic signs (e.g., where certain traffic signs (e.g., accident-prone areas) are detected are identified as critical points); traffic capacity (e.g., the top 20% (e.g., top 15-25% (e.g., top 15, 16, 17, 18, 19, 20, 21, 22, 23, 24, or 25%)) highest traffic capacity areas are identified as critical points); road geometry (e.g., roads with critical road geometry (e.g., curves, blind spots, hills, intersections (e.g., signalized intersections, stop sign intersections, yield sign intersections), roundabouts) are identified as critical points); traffic oscillation (e.g., points with significant traffic oscillations are identified as critical points); real-time traffic management (e.g., points with potential traffic management are identified as critical points); and/or real-time traffic incident (e.g., points with traffic incidents (e.g., accident, crash, congestion, construction or maintenance, weather-related event, etc.) or vehicle malfunction are identified as critical points).

As used herein, the terms “microscopic”, “mesoscopic”, and “macroscopic” refer to relative scales in time and space. In some embodiments, the scales include, but are not limited to, a microscopic level relating to individual vehicles (e.g., longitudinal movements (position, speed, car following, acceleration and deceleration, stopping and standing) and lateral movements (position, steering, lane keeping, lane changing)), a mesoscopic level relating to road corridors and/or segments (e.g., special event early notification, incident prediction, merging and diverging, platoon splitting and integrating, variable speed limit prediction and reaction, segment travel time prediction, and/or segment traffic flow prediction), and a macroscopic level relating to an entire road network (e.g., prediction of potential congestion, prediction of potential incidents, prediction of network traffic demand, prediction of network status, prediction of network travel time). In some embodiments, a time scale at a microscopic level is from less than 10 milliseconds and is relevant to tasks such as vehicle control instruction computation. In some embodiments, a time scale at a mesoscopic level is typically from 10 to 1000 milliseconds and is relevant to tasks such as incident detection and pavement condition notification. In some embodiments, a time scale at a macroscopic level is longer than 1 second and is relevant to tasks such as route computing.

As used herein, the automation and/or intelligence levels of vehicles (V), infrastructure (I), and system(S) are described with respect to an “intelligence level” and/or an “automation level”. In some embodiments, the vehicle intelligence and/or automation level is one of the following: V0: No automation functions; V1: Basic functions to assist a human driver to control a vehicle; V2: Functions to assist a human driver to control a vehicle for simple tasks and to provide basic sensing functions; V3: Functions to sense the environment in detail and in real-time and to complete relatively complicated driving tasks; V4: Functions to allow vehicles to drive independently under limited conditions and sometimes with human driver backup; and V5: Functions to allow vehicles to drive independently without human driver backup under all conditions.

In some embodiments, the infrastructure intelligence and/or automation level is one of the following: I0: No functions; I1: Information collection and traffic management wherein the infrastructure provides primitive sensing functions in terms of aggregated traffic data collection and basic planning and decision making to support simple traffic management at low spatial and temporal resolution; I2: I2X and vehicle guidance for driving assistance, wherein, in addition to functions provided in I1, the infrastructure realizes limited sensing functions for pavement condition detection and vehicle kinematics detection, such as lateral and/or longitudinal position, speed, and/or acceleration, for a portion of traffic, in seconds or minutes; the infrastructure also provides traffic information and vehicle control suggestions and instructions for the vehicle through I2X communication; I3: Dedicated lane automation, wherein the infrastructure provides individual vehicles with information describing the dynamics of surrounding vehicles and other objects on a millisecond time scale and supports full automated driving on CAVH-compatible vehicle dedicated lanes; the infrastructure has limited transportation behavior prediction capability; I4: Scenario-specific automaton wherein the infrastructure provides detailed driving instructions for vehicles to realize full automated driving in certain scenarios and/or areas, such as locations comprising predefined geo-fenced areas, where the traffic is mixed (e.g., comprises automated and non-automated vehicles); essential vehicle-based automation capability, such as emergency braking, is provided as a backup system in case the infrastructure fails; and I5: Full infrastructure automation wherein the infrastructure provides full control and management of individual vehicles under all scenarios and optimizes a whole road network where the infrastructure is deployed; vehicle automation functionality is not necessary provided as a backup; full active safety functions are available.

In some embodiments, the system intelligence and/or automation level is one of the following: S0: no function; S1: the system provides simple functions for individual vehicles such as cruise control and passive safety function; the system detects the vehicle speed, location, and distance; S2: the system comprises individual intelligence and detects vehicle functioning status, vehicle acceleration, and/or traffic signs and signals; individual vehicles make decisions based on their own information and have partially automated driving to provide complicated functions such as assisting vehicle adaptive cruise control, lane keeping, lane changing, and automatic parking; S3: the system integrates information from a group of vehicles and behaves with ad-hoc intelligence and prediction capability, the system has intelligence for decision making for the group of vehicles and can complete complicated conditional automated driving tasks such as cooperative cruise control, vehicle platooning, vehicle navigation through intersections, merging, and diverging; S4: the system integrates driving behavior optimally within a partial network; the system detects and communicates detailed information within the partial network and makes decisions based on both vehicle and transportation information within the network and handles complicated, high level automated driving tasks, such as navigating traffic signal corridors, and provides optimal trajectories for vehicles within a small transportation network; S5: vehicle automation and system traffic automation, wherein the system optimally manages an entire transportation network; the system detects and communicates detailed information within the transportation network and makes decisions based on all available information within the network; the system handles full automated driving tasks, including individual vehicle tasks and transportation tasks, and coordinates all vehicles to manage traffic.

In some embodiments, the system dimension is dependent on the vehicle and infrastructure dimensions, e.g., as represented by the following equation (S=system automation; V=vehicle intelligence; and I=infrastructure intelligence):

$$S = f ( V , I )$$

In some embodiments, vehicle intelligence is provided by and/or related to the CAV Subsystem and the infrastructure intelligence is provided by and/or related to the Connected Automated Highway (CAH) Subsystem (or one or more of RSU, Cloud, TCC, TCU, TOC. One of ordinary skill in the art may refer to SAE International Standard J3016,

“Taxonomy and Definitions for Terms Related to Driving Automation Systems for On-Road Motor Vehicles” (published in 2014 (J3016_201401) and as revised in 2016 (J3016_201609) and 2018 (J3016_201806)), which provides additional understanding of terms used in the art and herein. Also see U.S. Pat. No. 11,495,126, which is incorporated herein by reference.

In some embodiments, certain steps, operation, or processes described herein may be performed or implemented with one or more hardware modules, alone or in combination with other devices. In some embodiment, a software module is implemented with a computer program product comprising a computer-readable medium containing computer program code, which can be executed by a computer processor for performing any or all steps, operations or processes described.

### EASS

In some embodiments, the EASS comprises one or more of the following subsystems, which are empowered by AI models: a Crash Detection Subsystem, a Crash Prediction Subsystem, a Crash Warning Subsystem, a Crash Avoidance Subsystem, a Crash Impact Reduction Subsystem, an Emergency Response Subsystem, and/or a Management and Service Subsystem.

In some embodiments, the EASS can be hosted on one or more of five distinct components: a vehicle component, a road component, a cloud component, a pedestrian component, and/or a map component.

In some embodiments, the EASS provides services to various users, which include vehicles, government agencies, pedestrians, automobile companies, and technology companies. Additionally, the EASS offers services to applications, including service applications and management applications. The EASS exchanges data with multiple data resources, which may include vehicle data, road data, cloud data, map data, pedestrian data, and third-party data.

In some embodiments, the EASS comprises a Management and Service Subsystem, a Crash Warning Subsystem, a Crash Prediction Subsystem, a Crash Detection Subsystem and a Crash Avoidance Subsystem. The EASS receives historical data from the Historical Safety Data Module of the Management and Service Subsystem. The Crash Detection Subsystem provides the real-time data. The Crash Prediction Subsystem receives real time data and historical data from the Crash Detection Subsystem and Historical Safety Data Module, and predicts the crash probability. The Crash Warning Subsystem sends crash warning messages to the Management and Service Subsystem. The Crash Avoidance Subsystem receives real-time data from the Crash Detection Subsystem, historical data from Historical Safety Data Module, and prediction results from the Crash Prediction Subsystem. If the crash probability is high, the Crash Avoidance Subsystem provides measures to avoid the crash and output crash avoidance result.

In some embodiments, the EASS comprises a Management and Service Subsystem, a Crash Prediction Subsystem, and a Crash Avoidance Subsystem. The EASS receives historical data from the Historical Safety Data Module of the Management and Service Subsystem. The Crash Prediction Subsystem receives historical data from the Historical Safety Data Module, and then predicts the probability of a crash. The Crash Avoidance Subsystem receives historical data from the Historical Safety Data Module and prediction results from the Crash Prediction Subsystem. If the crash probability is higher than the pre-set threshold, the Crash Avoidance Subsystem provides measures to avoid the crash and output crash avoidance result.

In some embodiments, the EASS comprises a Management and Service Subsystem and a Crash Warning Subsystem. The EASS receives historical data from the Historical Safety Data Module of the Management and Service Subsystem, and sends historical data to the Crash Warning Subsystem. The Crash Warning Subsystem will identify whether the driving scenario is normal. If the driving scenario is not a normal driving scenario, the Crash Warning Subsystem sends a crash warning message to the Management and Service Subsystem.

In some embodiments, the EASS comprises a Management and Service Subsystem, a Crash Detection Subsystem, a Crash Prediction Subsystem, and a Crash Warning Subsystem. The Management and Service Subsystem comprises a Historical Safety Data Module, which provides historical data to both the Crash Prediction Subsystem and the Crash Detection Subsystem. The Crash Detection Subsystem, in turn, gathers real-time data and shares it with the Crash Prediction Subsystem. Using both historical and real-time data, the Crash Prediction Subsystem generates predictions and sends the results to the Crash Warning Subsystem. The Crash Warning Subsystem then issues a crash warning message to the Management and Service Subsystem.

In some embodiments, EASS comprises a Management and Service Subsystem, a Crash Prediction Subsystem, a Crash Impact Reduction Subsystem, and an Emergency Response Subsystem. The EASS receives historical data from the Historical Safety Data Module of the Management and Service Subsystem. The Crash Prediction Subsystem receives historical data from the Historical Safety Data Module, and then predicts the crash probability. The Crash Impact Reduction Subsystem receives historical data from the Historical Safety Data Module and prediction results from the Crash Prediction Subsystem. If the crash probability is higher than the predetermined threshold, the Crash Impact Reduction Subsystem provides measures to reduce the crash impact. The Emergency Response Subsystem provides emergency responses based on historical data, prediction results, and crash impact reduction results.

### Management and Service Subsystem

In some embodiments, the Management and Service Subsystem is responsible for distributing historical safety data from the Historical Safety Data Module to various subsystems, including the Crash Detection Subsystem, Crash Prediction Subsystem, Crash Warning Subsystem, Crash Avoidance Subsystem, Crash Impact Reduction Subsystem, and Emergency Response Subsystem. Additionally, the Management and Service Subsystem manages the flow of data between these subsystems.

In some embodiments, the Crash Detection Subsystem receives historical safety data from the Historical Safety Data Module via the Management and Service Subsystem. The Crash Detection Subsystem then processes the data and sends detection results to both the Crash Prediction Subsystem and the Storage and Backup Module. The Crash Prediction Subsystem, upon receiving the detection results, generates prediction results, which are subsequently sent to the Storage and Backup Module. The Management and Service Subsystem assesses the probability of a crash based on the prediction results. If the crash probability exceeds a predefined threshold, the Management and Service Subsystem forwards both detection and prediction results to the Crash Avoidance Subsystem.

Simultaneously, the Management and Service Subsystem evaluates the driving scenario. If the scenario is deemed abnormal, the prediction results are sent to the Crash Warning Subsystem, which processes the results and generates warning data, which are stored in the Storage and Backup Module. If the driving scenario is considered normal, the Management and Service Subsystem further assesses whether the crash probability exceeds predefined thresholds for various components, including vehicle, road, cloud, pedestrian, and map components. If the crash probability exceeds the threshold for any of these components, the detection and prediction results are sent to the Crash Avoidance Subsystem for further action. The Crash Avoidance Subsystem generates avoidance results, which are sent back to the Storage and Backup Module. The Management and Service Subsystem then determines whether the vehicle is capable of avoiding the crash. If the vehicle can avoid the crash, the avoidance results are stored and backed up in the Storage and Backup Module. However, if the vehicle is unable to avoid the crash, the avoidance results are sent to both the Crash Impact Reduction Subsystem and the Emergency Response Subsystem. The outputs from these subsystems, including impact reduction results and emergency response results, are also stored in the Storage and Backup Module.

Next, the Management and Service Subsystem determines whether the trip has ended. If it is the end of the trip, the Management and Service Subsystem stores and backs up the trip information in the Storage and Backup Module. If the trip is not complete, the Management and Service Subsystem returns to the Historical Safety Data Module to send updated historical safety data to all subsystems. The data within the Historical Safety Data Module is continuously updated by the Storage and Backup Module at each time step.

### Crash Detection Subsystem

In some embodiments, the vision-based sensors of the Crash Detection Subsystem comprise cameras and lidars. The camera provides visual data of the vehicle's surroundings, enabling the detection of obstacles, lane markings, and traffic signs, while the lidar uses pulses to measure distances and create a high-resolution 3D map of the environment. In some embodiment, the radar-based sensors of the Crash Detection Subsystem employ radio waves to detect objects, distance, and relative speed. In some embodiment, the ultrasonic sensors of the Crash Detection Subsystem are used to detect objects in close proximity to the vehicle, aiding in low-speed collision avoidance. In some embodiment, the inertial sensors of the Crash Detection Subsystem comprise accelerometers and gyroscopes. The accelerometer measures the rate of change in vehicle velocity, helping detect sudden stops or impacts, while the gyroscope detects changes in the vehicle's orientation and rotational movements, contributing to the understanding of the vehicle's dynamics during a potential crash. In some embodiment, the combined/multi-sensor system of the Crash Detection Subsystem integrates data from multiple sensor types (such as cameras, radar, and lidar) to create a more comprehensive understanding of the vehicle's surroundings, enhancing the accuracy and reliability of crash detection.

### Crash Prediction Subsystem

In some embodiments, the workflow of the Crash Prediction Subsystem is configured to comprise the following steps:
Step 1: The data fusion unit collects and integrates real-time data from the Crash Detection Subsystem, historical data from the Management and Service Subsystem, predicted data from other surrounding vehicles, and status data from the vehicle and traffic infrastructure.
Step 2: The data processing unit cleans, transforms, and organizes the collected data to create a structured input for prediction.
Step 3: The prediction unit produces a risk assessment prediction for the individual vehicle.
Step 4: The assessment unit assesses the risk condition and the risk level for the individual vehicle.
   Step 4.1: If the risk assessment unit identifies a potential danger in the upcoming segment or situations that might lead to a crash, the prediction unit sends prediction results to the Crash Warning Subsystem and Management and Service Subsystem.
   Step 4.2: If the risk assessment unit identifies an immediate threat where actions can be taken to prevent a crash, the prediction unit sends prediction results to the Crash Avoidance Subsystem and Management and Service Subsystem.
   Step 4.3: If the risk assessment unit identifies that a crash is imminent and unavoidable, the goal is to reduce the severity of the impact, the prediction unit sends prediction results to the Crash Impact Reduction Subsystem, Emergency Response Subsystem, and Management and Service Subsystem.
Step 5: The prediction unit updates prediction model weights.

In some embodiments, the prediction unit has a large-scale predictive modeling framework specifically designed for individual vehicle risk assessment. In some embodiments, a large-scale model refers to a complex computational structure capable of processing and analyzing vast amounts of data from multiple sources. In some embodiments, the architecture of the large-scale model includes but is not limited to, Deep Reinforcement Learning models and Graph Transformers models, which are known for their ability to identify intricate patterns within large datasets and parameters. In some embodiments, advanced algorithms within the model assess the probability of a vehicle being involved in a crash by examining its current state and comparing it with historical patterns of crashes. For example, if a vehicle's behavior deviates significantly from normal traffic flow or if it exhibits patterns that have been previously identified as precursors to accidents, the risk level associated with that vehicle is elevated accordingly. In some embodiments, the large-scale model employs sophisticated techniques such as feature engineering and anomaly detection to enhance its predictive prowess. By pinpointing unusual patterns in a vehicle's behavior or in the surrounding environment that might not be immediately obvious, the model can alert the vehicle to emerging risks.

In some embodiments, the large-scale models are trained using historical data. In some embodiments, the large-scale models are used to infer crash probability. In some embodiments, the large-scale models are deployed in one or more of following hosts: cloud, edge, road, and/or vehicle components.

### Crash Warning Subsystem

In some embodiments, the Crash Warning Subsystem is depicted as a structured workflow. The Crash Warning Subsystem is compartmentalized into two primary functional areas: Real-time Warning and Offline Warning. The input data is processed by the Crash Warning Subsystem, where the collected information undergoes computation and categorization into warning messages. For Real-time Warnings, the subsystem interacts with different entities-vehicles, roadside units, cloud services, and pedestrians. Vehicles receive computed warning results and subsequently provide warning instructions. Similarly, the roadside units receive computed warning results and provide warning instructions. The cloud services receive and process data to offer warning instructions. The pedestrians are also recipients of computed warning results and warning instructions. In parallel to real-time processing, an Offline Warning feature is also disclosed. Here, the Crash Warning Subsystem records near-miss events and unsafe acts and generates offline warnings. The Crash Warning Subsystem not only reacts in real-time, but also compiles data for preventive measures and retrospective analyses.

In some embodiment, the hardware of warning devices on vehicle component is configured to comprise:
a) OBUs, which execute a multitude of tasks such as fundamental data processing, intricating computations, versatile hubs, facilitating seamless communication, navigation, and transactional operations; and
b) Vehicle-based Alarm System, which provides visual and audible alert to dangerous driving behaviors for the vehicle and its occupants.

In some embodiment, the hardware of warning devices on pedestrian component is configured to comprise:
a) Phones, which receive relevant warning messages to alert people to potentially dangerous situations in their neighborhood; and
b) Vest, which alerts emergency responders to potentially dangerous situations in the surrounding area through vibration and audible sounds to prevent secondary accidents.

In some embodiment, the hardware of warning devices on roadside component is configured to comprise:
a) RSUs, which are also communication nodes, and facilitate the exchange of information among vehicles, pedestrian, Cloud and the broader transportation network;
b) Telematics Control Units (TCUs), which handles vehicle-to-vehicle (V2V) and vehicle-to-infrastructure (V2I) communications, which are essential for advanced driver-assistance systems (ADAS); and
c) Information Board, which displays relevant traffic information and alerts to potential traffic safety hazards in the vicinity.

In some embodiment, the hardware of warning devices on the Cloud component is configured to comprise Wireless Communication Chips, which facilitates Wi-Fi, Bluetooth, and cellular connections for data exchange and remote vehicle monitoring.

### Crash Avoidance Subsystem

In some embodiments, the Data Processing Unit in the Crash Avoidance Subsystem is configured to comprise:
a) Microprocessors, which are general-purpose processors that perform a wide range of tasks, from basic data handling to complex computations;
b) Microcontrollers, which are typically used for more specific, real-time tasks in vehicle systems; and
c) Digital Signal Processors (DSPs), which are specialized processors designed to handle complex mathematical computations on audio, video, and sensor data in real-time, aiding in tasks such as voice recognition and sensor fusion.

In some embodiment, the Crash Avoidance Assistant Unit in the Crash Avoidance Subsystem is configured to comprise:
a) Telematics Control Units (TCUs), which handle vehicle-to-vehicle (V2V) and vehicle-to-infrastructure (V2I) communications, which are essential for advanced driver assistance systems (ADAS);
b) Wireless Communication Chips, which facilitate Wi-Fi, Bluetooth, and cellular connections for data exchange and remote vehicle monitoring; and
c) CAN (Controller Area Network) Controllers, which manage internal communications between vehicle systems, ensuring smooth data transfer and coordination between various sensors, ECUs, and processors.

In some embodiment, the computing modules in the Vehicle Control and Coordination Unit, Vehicle Takeover and Control Unit, and Human Takeover and Control Unit in the Crash Avoidance Subsystem are configured to comprise:
a) Graphics Processing Units (GPUs), which are designed for rendering graphics but are increasingly used in vehicles for parallel processing tasks, crucial for AI and machine learning;
b) Neural Network Processors, which are designed to efficiently run machine learning models, especially useful in interpreting sensor data and conducting predictive analyses; and
c) Central Processing Unit (CPU), which is the main processor in a computing unit, handling general-purpose processing tasks and coordinating between different vehicle systems.

In some embodiment, the Electronic Control Units in the Vehicle Control and Coordination Unit, Vehicle Takeover and Control Unit, and Human Takeover and Control Unit in the Crash Avoidance Subsystem are configured to comprise:
a) Central ECU, which acts as the primary computer in the vehicle, coordinating data from various systems;
b) Dedicated Safety ECUs, which are specialized units for handling safety-critical functions, like collision detection and airbag deployment; and
c) Body Control Modules, which manage functions related to the vehicle's body, such as lighting, door locks, and wipers, ensuring seamless integration with other systems.

In some embodiment, the Generative Computation and Simulation Unit in the Crash Avoidance Subsystem is configured to comprise:
a) Digital Twins, which are virtual replicas of vehicle systems, enabling simulation and testing of various scenarios to predict performance and optimize operations;
b) Monte Carlo Simulators, which generate random samples for statistical analysis, helping assess risks and performance outcomes in uncertain scenarios;
c) Predictive Analytics Modules, which use historical data to generate models that predict future vehicle behavior, aiding in maintenance, performance optimization, and risk assessment;
d) Simulation Platforms, which allow for comprehensive testing of vehicle systems in virtual environments, identifying potential issues and ensuring reliability; and/or
e) Machine Learning and Deep Learning Algorithms, which are used to analyze sensor data and other inputs, generating insights and adaptive behaviors, ensuring that the vehicle can respond effectively to changing conditions.

In some embodiment, the memory and storage in the Crash Avoidance Subsystem is configured to comprise:
a) RAM (Random Access Memory), which provides temporary data storage and quick access by the processor; and
b) Flash Memory and Solid-State Drives (SSDs), which are used for longer-term data storage, including firmware, maps, and software updates.

### Crash Impact Reduction Subsystem

In some embodiments, the Crash Impact Reduction Subsystem comprises a Data Processing Unit and an Assessment Unit. In some embodiments, the Crash Impact Reduction Subsystem comprises one or more of the following: a Crash Digital Twin Unit, a Candidate Strategy Generation Unit, and/or a Takeover and Control unit. In some embodiments, the Data Processing Unit integrates the crash detection results, crash prediction results, crash warning results, crash avoidance results and historical safety data, providing a comprehensive information foundation for all levels. In some embodiments, the Assessment Unit offers quantitative risk assessments for all levels, aiding the system in decision-making across different scenarios.

In some embodiments, the Data Processing Unit receives the crash detection results from the Crash Detection Subsystem, crash prediction results from the Crash Prediction Subsystem, crash warning results from Crash Warning Subsystem, crash avoidance results from Crash Avoidance Subsystem, and historical safety data from Management and Service Subsystem to provide comprehensive and up-to-date information for the crash impact reduction process. In some embodiments, the Crash Digital Twin Unit simulates traffic crashes by modeling vehicle dynamics, road conditions, and environmental variables to predict collision scenarios and their potential impact on vehicle occupants and surroundings. In some embodiments, the Candidate Strategy Generation Unit analyzes the simulated data from the Crash Digital Twin Unit and generates a set of horizontal and vertical control commands aimed at reducing crash impact. In some embodiments, the Assessment Unit quantitatively evaluates the risks associated with each command and their expected benefits in terms of safety and overall system performance. In some embodiments, the Takeover and Control Unit takes control of vehicles by generating and sending control instructions and sends information to the Management and Service Subsystem for backup.

In some embodiments, when the Assessment Unit estimates whether the probability of a crash exceeds a predefined threshold, the Crash Digital Twin Unit accelerates the simulation speed akin to a time machine. Subsequently, the Candidate Strategy Generation Unit analyzes the data generated by the Crash Digital Twin Unit, thereby generating various horizontal and vertical control commands. Additionally, following a crash, the Crash Digital Twin Unit can retrospect the crash process, facilitating the determination of the cause of the crash.

In some embodiments, the Crash Impact Reduction Subsystem is applicable to autonomous driving levels ranging from L1 to L5. At the L1 level, the Crash Impact Reduction Subsystem implements collision warning and auxiliary braking and supports the drivers in making safe driving decisions through the data processing unit. At the L2/L3 level, the Crash Impact Reduction Subsystem realizes automatic emergency braking through the Crash Digital Twin Unit and Data Processing Unit to mitigate collision impact. The Crash Digital Twin Unit and Candidate Strategy Generation Unit generate multiple horizontal and vertical control commands to mitigate collision impact. The Assessment Unit evaluates the risk and expected benefits of commands, supporting more autonomous decision-making. At the L4/L5 level, the Crash Impact Reduction Subsystem implements automatic takeover and control. The Takeover and Control Unit proactively takes control measures, automatically operating the vehicle based on the risk assessment. The L4/L5 level can achieve advanced crash impact functions through all units to support highly autonomous driving tasks.

In some embodiments, at the L1 level, the Crash Impact Reduction Subsystem can achieve basic crash impact functions. At the L2/L3 level, the Crash Impact Reduction Subsystem achieves intermediate crash impact functions. At the L4/L5 level, the Crash Impact Reduction Subsystem can achieve advanced crash impact functions and support highly autonomous driving tasks. In some embodiments, the basic crash impact functions assist drivers in making safe driving decisions, such as speed adjustment and maintaining a safe distance from the vehicle and other basic functions, and providing basic warning information: including pre-collision warnings, lane departure warnings, etc., to help drivers avoid potential collision risks. In some embodiments, the intermediate crash impact functions support more advanced self-driving vehicles and tasks, realizing crash scenario simulation, making more precise prediction and analysis of possible collision scenarios, and improving prediction accuracy. In some embodiments, it generates more diverse and complex horizontal and vertical control commands. Moreover, it provides further risk and expected benefit assessment of commands to support more autonomous decision making, including automatic selection and execution of the most appropriate collision avoidance strategy. In some embodiments, the advanced crash impact functions support highly automated autonomous driving tasks, wherein the vehicle is able to make fully autonomous decisions without human intervention, including identifying potential collision risks, selecting and executing collision avoidance strategies, and the vehicle is able to deal with more complex traffic environments and contingencies, such as automatically rerouting to avoid crashes, or in extreme weather conditions to maintain driving safety.

In some embodiments, the Crash Impact Reduction Subsystem is configured to reside in one or more of vehicle component, road component, cloud component, pedestrian component, and map component. In some embodiments, the output data of Crash Impact Reduction Subsystem is configured to comprise of control instructions for current AV and/or warning information to other AVs.

### Emergency Response Subsystem

In some embodiments, the Emergency Alert Unit could significantly benefit from the application of digital twin technology. A digital twin of the incident area could be created in real-time, allowing responders to visualize the scene before they arrive. This virtual model can incorporate live data from various sources, including surveillance cameras, satellite imagery, and sensors, to provide a comprehensive overview of the situation. This enables the Emergency Alert Unit to evaluate the incident more accurately, plan the deployment of resources more effectively, and disseminate critical alerts to relevant parties with detailed information about the hazards, access routes, and areas of concern.

In some embodiments, the Minor Injury Response Unit could use digital twin technology for training purposes and incident response planning, although its direct application during emergency responses might be limited. A digital twin of various emergency scenarios could be used to simulate the assessment and treatment of victims, allowing responders to practice and improve their skills in a virtual environment. While the practical application of a digital twin for real-time minor injury response might be limited, it could enhance preparedness and the efficiency of the unit's operations by enabling virtual drills and scenario planning.

In some embodiments, the Major Injury Response Unit could leverage digital twin technology to enhance its operational capabilities significantly. By creating a digital twin of the emergency scene and integrating it with patient data, responders can perform virtual triage, prioritize interventions, and plan medical evacuations more effectively. This approach could also facilitate remote medical consultations, allowing experts not present on the scene to provide advice based on the virtual representation of the incident and patients. Additionally, digital twins could be used for training, enabling the unit to simulate complex medical emergencies and practice response strategies in a controlled virtual environment.

In some embodiments, the Hazardous Material Removal and Risk Mitigation Unit could find substantial benefits from the application of digital twin technology. A digital twin of the crash area, including the dispersion of hazardous materials, could be created using data from sensors and predictive models. This would allow the unit to simulate the spread of hazardous substances, assess the effectiveness of different containment and neutralization strategies in a virtual environment, and implement the best course of action in the real world. Such simulations could also identify potential risks to responders, the public, and the environment, enabling the unit to take preventive measures to minimize exposure and damage.

In some embodiments, the Road Clearance and Traffic Recovery Unit might have limited potential usage for digital twin technology in their direct operational activities, given the physical nature of clearing obstructions and debris. The digital twin technology could be useful for planning and coordination purposes, creating simulations of the incident scene to determine the most effective strategies for debris removal and traffic management. The digital twin technology could also help in predicting the impact of road closures on traffic flow and devising detour routes to minimize congestion. While the practical, hands-on work of this unit may not directly involve digital twins, the planning and strategy aspects could certainly benefit from such simulations.

In some embodiments, with higher levels of vehicle and system intelligence and automation, typically above L2, including L2, L2+, L3, L3+, L4 and L4+, the Emergency Alert Unit is capable of providing Automated Coordination. The Minor Injury Response Unit is capable of providing Advanced Diagnostics, and Automated Medical Assistance. The Major Injury Response Unit is capable of providing Robotic Surgery Assistance and Enhanced Triage and Treatment. The Hazardous Material Removal and Risk Mitigation Unit is capable of providing Advanced Detection and Analysis, and Autonomous Containment and Cleanup. The Road Clearance and Traffic Recovery Unit is capable of providing Predictive Traffic Management and Automated Clearance Operations.

### EXAMPLES

### Crash Detection Subsystem

In some embodiments, the LIDAR (Light Detection and Ranging) in the Crash Detection Subsystem is configured to comprise one or more of the following:
a) Velodyne VLP-16: offers a 360-degree horizontal field of view, 16 channels, and a range of 100 meters.
b) Luminar Hydra: provides a range of up to 250 meters with 1200×1000 resolution, offering centimeter-level accuracy.
c) Quanergy M8: features 8 scanning beams, a 360-degree horizontal field of view, and a range of 200 meters.
d) Ouster OS1: provides a 128-channel resolution, 120-degree vertical field of view, and a range of 120 meters.
e) Innoviz One: offers a 73-degree vertical field of view, 0.1-degree angular resolution, and a range of 250 meters.

In some embodiments, the cameras in the Crash Detection Subsystem are configured to comprise one or more of the following:
a) Mobileye EyeQ4: offers high-resolution imaging, advanced image processing, and AI algorithms for object recognition and lane detection.
b) Aptiv Wide-Angle Camera: provides up to 8 MP resolution with a 120-degree field of view, ideal for lane-keeping and traffic sign recognition.
c) Nvidia Drive PX: features high-resolution cameras with integrated AI algorithms, designed for real-time image processing and detection.
d) Continental Surround View Camera: offers a 360-degree field of view with a 2 MP resolution, aiding in parking and near-field object detection.
e) Bosch Mono Camera: provides a 1.2 MP resolution and a 70-degree field of view, optimized for traffic sign recognition and lane-keeping.

In some embodiments, the Radar (Radio Detection and Ranging) in the Crash Detection Subsystem is configured to comprise one or more of the following:
a) Long-Range Radar
   Bosch's LRR 4.0: has a range of up to 250 meters, operates at 77 GHz, and offers robust long-distance capabilities for highway driving.
   Continental's ARS 410: provides a range of up to 300 meters, an azimuth angle of 60 degrees, and features enhanced object classification.
b) Medium-Range Radar
   Bosch's MRR: offers a range of 160 meters, operates at 77 GHz, and provides both near and far-field coverage.
   Continental's ARS 408-21: has a range of up to 250 meters, an azimuth angle of 60 degrees, and a 3D mode for detailed environment mapping.
c) Short-Range Radar
   Delphi SRR: features a range of 80 meters, operates at 77 GHz, and is ideal for complex urban environments with multiple object detection.
   Valeo's SRR: provides a range of 100 meters, operates at 77 GHz, and includes dual-mode functionality for both pedestrian and vehicle detection.
d) Ultra-Wideband Radar
   Aptiv's UWB Radar: covers up to 50 meters with ultra-high resolution for detailed object recognition and scene interpretation.
   Bosch's UWB Sensor: operates with high bandwidth for precise detection in cluttered environments.
e) Imaging Radar
   Aptiv's Smart Radar: has a range of 300 meters, operates at 79 GHz, and offers detailed 3D imaging for enhanced object classification and tracking.
   Continental's High-Resolution 3D Radar: provides exceptional depth perception and angular resolution over 200 meters.
f) Corner Radar
   Delphi's Corner Radar: offers a range of 50 meters, wide-angle coverage, and is optimized for intersection assistance and blind spot monitoring.
   Bosch's Corner Radar CRC: provides a range of 75 meters, with advanced capabilities for cross traffic and pedestrian detection.
g) Multifunction Radar
   Valeo's Scala Multi-function Radar: has a range of 200 meters, operates at 76-77 GHz, and includes multiple beams for comprehensive object detection.
   Aptiv's Multi-mode Radar: offers a range of 250 meters, operates at 77 GHZ, and integrates various functions like adaptive cruise control and collision avoidance.

In some embodiments, the GNSS (Global Navigation Satellite System) in the Crash Detection Subsystem is configured to comprise one or more of the following:
a) u-blox NEO-M8U: offers centimeter-level accuracy, supports GPS, GLONASS, and Galileo, with RTK corrections.
b) Garmin GPS 19×: provides real-time kinematic (RTK) corrections with an accuracy of 0.01 degrees per hour, supporting GPS and Galileo.
c) Trimble BX992: features dual-frequency support with RTK corrections, providing centimeter-level positioning accuracy.
d) Hemisphere Phantom 40: offers multi-constellation support with centimeter-level accuracy and RTK corrections.
e) Septentrio AsteRx-i: provides centimeter-level positioning accuracy, supporting multiple constellations, and includes an integrated IMU.

In some embodiments, the Inertial Measurement Units (IMU) in the Crash Detection Subsystem are configured to comprise one or more of the following:
a) Bosch BHI260AB: combines gyroscopes and accelerometers, offering 6 degrees of freedom and an accuracy of 0.01 degrees per second.
b) Honeywell HG4930: provides accurate yaw, pitch, and roll measurements, with an error rate of less than 0.01 degrees per hour.
c) STMicroelectronics ASM330LHH: offers 6 degrees of freedom with a gyroscope accuracy of 0.05 degrees per second and an accelerometer range of ±2 g to ±16 g.
d) Analog Devices ADIS16480: provides a 10 degrees of freedom sensor with yaw, pitch, and roll measurements, with an error rate of less than 0.01 degrees per hour.
e) InvenSense MPU-9250: combines gyroscopes, accelerometers, and a magnetometer, offering 9 degrees of freedom with high accuracy.

In some embodiments, the drones in the Crash Detection Subsystem are configured to comprise one or more of the following:
a) DJI Phantom 4 RTK: This drone is equipped with a high-precision RTK module, which provides accurate data collection. It's commonly used for mapping and surveying, including traffic monitoring and analysis.
b) Parrot Anafi USA: This drone offers 32× zoom, thermal imaging, and a high-resolution 4K camera, making it suitable for detailed traffic monitoring and incident detection.
c) SenseFly eBee X: Known for its endurance and flexibility, this fixed-wing drone can cover large areas and provide high-resolution imagery for traffic studies and road monitoring.
d) DJI Matrice 300 RTK: This drone is equipped with multiple payload configurations, including high-resolution cameras and LiDAR, making it ideal for traffic detection and infrastructure inspection.
e) Skydio 2: With its advanced obstacle avoidance and autonomous flight capabilities, this drone can be used for close-range traffic monitoring and surveillance.

### AI Models

In some embodiments, an example AI model is configured to comprise one or more of the following:
a) Deep Neural Networks (DNNs): Useful for analyzing visual data from cameras for detecting potential hazards.
b) Recurrent Neural Networks (RNNs): Effective for sequence prediction and time-series analysis, which are crucial for predicting vehicle trajectories.
c) Graph Neural Networks (GNNs): Useful for modeling interactions between vehicles and other objects in the environment
d) Deep Q-Networks (DQN): For learning optimal driving policies through simulation and real-world data.
e) Gradient Boosting Machines (GBM): Such as XGBoost, LightGBM, or CatBoost for combining predictions from multiple weak models to improve accuracy.
f) Transformer Models: Such as BERT, GPT, or T5 for leveraging attention mechanisms to process sequential data and improve natural language understanding tasks.
g) Diffusion Models: Such as Denoising Diffusion Probabilistic Models (DDPM) and Latent Diffusion Models (LDM) for generating high quality synthetic data by modeling the process of data corruption and subsequent recovery.

### Crash Prediction Subsystem

In some embodiments, an example in a Crash Prediction Subsystem is configured to comprise one or more of the following:

a. Data Processing Units:
a) Intel Xeon Scalable Processors, AMD EPYC Processors: High-Performance Central Processing Unit (CPU) for executing complex algorithms and real-time data processing related to crash prediction.
b) NVIDIA Tesla V100, NVIDIA A100 Tensor Core GPU: Graphics Processing Unit (GPU) for accelerating the computation intensive tasks involved in prediction models, especially those using deep learning.
c) Xilinx Virtex UltraScale+ FPGA, Intel Stratix 10 FPGA, Google Tensor Processing Unit (TPU): Field Programmable Gate Arrays (FPGAs) or Application Specific Integrated Circuits (ASICs) for efficient execution of specific prediction algorithms and models.
   b. Machine Learning Models:
a) NVIDIA Jetson AGX Xavier, Intel Movidius Myriad X: Hardware designed specifically to speed up neural network computations used in crash prediction models.
b) NVIDIA TensorRT, Intel OpenVINO Toolkit: Specialized processors optimized for running machine learning inference tasks on collected data to predict potential collisions.
   c. Data Storage:
a) Samsung 970 PRO NVMe SSD, Intel Optane SSD: Solid-State Drives (SSD) for fast storage and retrieval of large datasets used in training and running prediction models.
b) Redis, Apache Ignite: In Memory Databases to facilitate rapid access to data required for real-time predictions.
   d. Prediction Analytics Software:
a) TensorFlow, PyTorch, Scikit learn: Software platforms and tools that run on the aforementioned hardware to analyze data patterns and predict potential crash scenarios.
b) Apache Flink, Apache Kafka: Systems designed to process and analyze data as it is collected, enabling immediate predictions.
   e. Middleware:
a) Apache NiFi, Talend Data Integration: Software that facilitates the integration of various data sources and processing units to ensure seamless data flow and processing for prediction tasks.

### Crash Warning Subsystem

In some embodiments, an example hardware of warning devices on vehicles is configured to comprise one or more of the following:

a. Mirrors:
a. APA Auto Parts Avenue Mirrors, designed to flash as an alert when adjacent vehicles are detected by the system's radar.
   b. Audible alert:
a. Compustar PRO RFX-P2WT13-SF, comprises a 105 dB+ alarm siren and a full-color LCD screen to provide audible and visual warnings. Additionally, this system has the capability to send warning messages to the driver's smartphone remotely.

In some embodiments, an example hardware of warning devices on pedestrians is configured to comprise one or more of the following:

a. Phones:
a. Apple iPhone: Equipped with high-quality speakers, the iPhone can deliver clear and loud auditory warnings to pedestrians. It features high-resolution displays capable of showing visual alerts and safety instructions with clarity under various lighting conditions.

### Crash Avoidance Subsystem

In some embodiments, the Data Processing Unit in the Crash Avoidance Subsystem is configured to comprise one or more of the following:
a) Microprocessor: Intel Core i7—A high-performance microprocessor from Intel, capable of handling complex computations and multiple tasks efficiently.
b) Microcontroller: STM32F446—A microcontroller by STMicroelectronics, widely used in automotive applications for its robust real-time performance and low power consumption.
c) Digital Signal Processor: TMS320C6678—A DSP from Texas Instruments, designed for high-performance applications in image and audio processing, especially in automotive safety systems.

In some embodiments, the Crash Avoidance Assistant Unit in the Crash Avoidance Subsystem is configured to comprise one or more of the following:
a) Telematics Control Unit (TCU): LG AT-7000—LG's advanced TCU that provides vehicle-to-everything (V2X) communications, enhancing connectivity and safety features in vehicles.
b) Wireless Communication Chip: Qualcomm Snapdragon X55—A 5G chipset by Qualcomm that facilitates high-speed wireless communications and enhances capabilities for autonomous vehicle connectivity.
c) CAN Controller: MCP2515—A stand-alone CAN controller developed by Microchip Technology, which allows microcontrollers to interface with CAN networks without the need for extensive CAN support.

In some embodiments, the Computing Modules in the Vehicle Control and Coordination Unit, Vehicle Takeover and Control Unit, and Human Takeover and Control Unit in the Crash Avoidance Subsystem are configured to comprise one or more of the following:
a) Graphics Processing Unit: NVIDIA GTX 2080—A powerful GPU by NVIDIA, often used in high demand video processing and increasingly in parallel processing tasks for autonomous driving applications.
b) Neural Network Processor: Google Edge TPU—A tiny, low-power neural network processor designed by Google, aimed at running AI at the edge, particularly in IoT devices including vehicles.
c) Central Processing Unit: AMD Ryzen 9—A top-of-the-line CPU from AMD, known for its high-speed processing capabilities and efficiency, used in complex computing environments.

In some embodiments, the Electronic Control Units in the Vehicle Control and Coordination Unit, Vehicle Takeover and Control Unit, and Human Takeover and Control Unit in the Crash Avoidance Subsystem are configured to comprise one or more of the following:
a) Central ECU: Bosch ECU 9.1—A central electronic control unit by Bosch that manages various vehicle dynamics and safety functions, enhancing overall vehicle performance and safety.
b) Dedicated Safety ECU: Continental MK C1—This ECU by Continental specifically manages braking and stability control systems, crucial for collision avoidance.
c) Body Control Module: Delphi BCM—A body control module from Delphi that manages vehicle body electronics such as lighting, windows, and door functions.

In some embodiments, the Generative Computation and Simulation Unit in the Crash Avoidance Subsystem is configured to comprise one or more of the following:
a) Digital Twin: Siemens Simcenter—A software solution by Siemens that creates a virtual model of a physical vehicle system, used extensively in simulation and testing.
b) Monte Carlo Simulator: MathWorks MATLAB—MATLAB from MathWorks includes powerful tools for conducting Monte Carlo simulations to model and analyze risk in various systems.
c) Predictive Analytics Module: IBM SPSS Modeler—A predictive analytics tool from IBM that provides insights and forecasts based on data analysis, useful in predictive maintenance and decision making.

In some embodiments, the Memory and Storage in the Crash Avoidance Subsystem is configured to comprise one or more of the following:
a) RAM: Corsair Vengeance—High-speed RAM from Corsair, known for its reliability and performance, suitable for high performance computing tasks.
b) Flash Memory: Samsung Evo-High-endurance flash memory from Samsung, ideal for data storage in demanding environments like automotive applications.
c) SSD: Western Digital Blue-A solid state drive from Western Digital, offering quick data access and reliable storage for software updates and system data.

### Crash Impact Reduction Subsystem

In some embodiments, an example of a Crash Impact Reduction Subsystem is configured to comprise one or more of the following:

a. Vehicle Application
i. Toyota Pre-crash Seatbelt: reduces collision injury through eliminating seatbelt slack before the collision, restraining the driver/passenger at an earlier stage.
ii. Toyota Pre-crash Brake Assist: assists immediately by activating the Pre-crash Brake Assist when a collision is detected as inevitable, increasing the braking force to reduce the speed before the collision occurs.
iii. Volkswagen Front Assist Pre-Collision Safety System and Pre-crash Protection System: The Front Assist system can automatically alert the driver and initiate automatic braking when a collision risk is detected. The Pre-crash system pre-tensions seat belts and closes windows and sunroofs to prepare for a potential collision.
   b. Roadside Application
i. Roadside Airbag: reduces the impact of the crash which is designed to inflate extremely rapidly then quickly deflate during a collision or impact, comprising of the airbag cushion, a flexible bag, inflation module, and controller module.
ii. NVIDIA Geforce RTX 3090, AMD Radeon RX 6900 XT: processes and analyze large volumes of data from multiple roadside sensors in real-time.
iii. Qualcomm QCA7006AQ: supports Ethernet digital interfaces to enable higher HomePlug roadside data rate connectivity applications separate from HPGP.
   c. Cloud Application
i. OnStar Wireless Communication Module: transmits vehicle system data to the service center in case of emergency.
ii. Amazon Web Services AWS: supports the development and operation of vehicle collision warning systems by providing robust data processing, machine learning, and IoT services for real-time data analysis and system optimization.

### AI Model Example for Crash Impact Reduction Subsystem

In some embodiments, the Data Processing Unit utilizes AI models such as BERT or GPT to process and interpret natural language information, including warning messages. The Vision Transformers (ViT) are implemented for processing image data, while Long Short-Term Memory networks (LSTMs) are employed to analyze and manage time-series data. In some embodiments, the Candidate Strategy Generation Unit utilizes Deep Reinforcement Learning (DRL) models to generate response strategies. In some embodiments, the Crash Digital Twin Unit uses Generative Adversarial Networks (GANs) to create digital twins of vehicles and environments, simulating various crash scenarios, while the Finite Element Analysis (FEA) is employed for more accurate simulation of vehicle responses during collisions. In some embodiments, the Assessment Unit employs Random Forest algorithms, CNNs, and Transformers for crash risk assessment and in-depth analysis of image data and other data types.

### Emergency Response Subsystem

In some embodiments, the example for the Integrated Communications System with GPS, broadband, and satellite capabilities used in emergency response comprises Inmarsat Global Xpress (GX) service. It provides seamless, mobile, global coverage with robust, quickly deployable terminals like the BGAN terminal for reliable broadband services.

Another example is the Digisat DSAT Series vehicular mounted mobile VSAT satellite internet antennas, which deliver commercial-grade internet speeds and feature automatic satellite pointing.

In some embodiments, the Minor Injury Response Unit could utilize the Philips HeartStart FRx Defibrillator, which is designed for on-the-spot first aid by bystanders and first responders. Additionally, the SAM Splint is a common choice for a Compact Splint Set due to its versatility and ease of use.

In some embodiments, advanced support in critical situations provided by a Major Injury Response Unit might include the ZOLL X Series Monitor/Defibrillator, known for its comprehensive capabilities in a portable device, and the Philips Respironics Trilogy 100 Portable Ventilator for patient ventilation support.

In some embodiments, the Hazmat Suits could be represented by the DuPont Tychem® 2000 QC127S for chemical and biological protection. The Honeywell BW™ Ultra is an example of a portable five-gas detector for chemical detection in hazardous material incidents.

In some embodiments, for Road Clearance and Traffic Recovery Units, a representative mini bulldozer could be the Caterpillar 259D Compact Track Loader. The traffic management may be facilitated by the DJI Mavic 2 Enterprise drone, which can be equipped with accessories beneficial for directing vehicles and assessing traffic post-incident.

1-97. (canceled)

98. An Enterprise Active Safety system (EASS), configured to improve safety and minimize losses from safety events, comprising a vehicle component and a cloud component,
wherein the vehicle component comprises a Management and Service Subsystem, a Crash Detection Subsystem, a Vehicle-based Crash Prediction Subsystem, and a Vehicle-based Crash Impact Reduction Subsystem;
wherein the Management and Service Subsystem comprises: a) a Management and Allocation Module configured to provide a management method of the EASS; and b) an Update and Maintenance Software Module configured to update and maintain the software of the EASS;
wherein the Vehicle-based Crash Impact Reduction Subsystem comprises a Vehicle-based Takeover and Control Unit configured to take control of a vehicle by receiving control instructions from the cloud component;
wherein the cloud component comprises a Cloud-based Crash Prediction Subsystem, a Crash Avoidance Subsystem, and a Cloud-based Crash Impact Reduction Subsystem;
wherein the Cloud-based Crash Prediction Subsystem comprises: a) a Data Fusion Unit configured to integrate real-time data from the Crash Detection Subsystem, historical data from the Management and Service Subsystem, predicted data from other surrounding vehicles, and status data from the vehicle and the cloud component; b) a Prediction Unit configured to utilize large-scale models to predict and conduct risk assessment for individual vehicles at a microscopic level; and c) an Assessment Unit configured to assess the risk level, and evaluate potential collision scenarios, including Fatality, Serious Injury, Minor Injury, Near Miss, and Unsafe Act; and
wherein the Cloud-based Crash Impact Reduction Subsystem comprises: a) a Crash Digital Twin Unit configured to simulate crashes by modeling vehicle dynamics, road conditions, and environmental variables to predict collision scenarios and their potential impact on vehicle occupants and surroundings; b) a Candidate Strategy Generation Unit configured to analyze the simulated data from the Crash Digital Twin Unit through finite element analysis, sensitivity analysis, and simulation-based optimization, and generate a set of horizontal and vertical control commands aimed at reducing crash impact; and c) a Cloud-based Takeover and Control Unit configured to generate and send control instructions to the vehicle.

99. The EASS of claim 98, wherein the management method comprises:
a) selecting and communicating information or results between subsystems of the EASS; and/or
b) selecting a subsystem based on a host component, a driving environment, and a vehicle intelligence level.

100. The EASS of claim 98, wherein the Crash Detection Subsystem comprises a Data Processing Unit, a Crash Identification Unit, and a Crash Validation Unit,
wherein the Data Processing Unit is configured to process collected information from the vehicle component, and historical data from the Crash Management and Service Subsystem;
wherein the Crash Identification Unit is configured to identify a crash type and a severity level; and
wherein the Crash Validation Unit is configured to validate accuracy and confidence of the identified crash data.

101. The EASS of claim 100, wherein the Crash Detection Subsystem is configured to generate outputs comprising one or more of the following detection results:
a) information of past crashes, wherein the Crash Detection Subsystem sends output data to the Crash Avoidance Subsystem and the Crash Management and Service Subsystem;
b) information of predicted crashes, wherein the Crash Detection Subsystem sends output data to the Vehicle-based Crash Prediction Subsystem, the Crash Avoidance Subsystem, the Vehicle-based Crash Impact Reduction Subsystem, and the Management and Service Subsystem; and/or
c) information of unsafe acts and near misses, wherein the Crash Detection Subsystem sends output data to the Vehicle-based Crash Prediction Subsystem, the Crash Avoidance Subsystem, and the Management and Service Subsystem.

102. The EASS of claim 98, wherein the Vehicle-based Crash Prediction Subsystem is configured to provide Microscopic Level Prediction, Mesoscopic Level Prediction, and Macroscopic Level Prediction,
wherein the Microscopic Level Prediction is configured to conduct prediction at a microscopic level relating to an individual vehicle, including longitudinal movements and lateral movements, with a time scale of less than 10 milliseconds;
wherein the Mesoscopic Level Prediction is configured to conduct prediction at a mesoscopic level relating to road corridors and segments, with a time scale from 10 to 1000 milliseconds; and
wherein the Macroscopic Level Prediction is configured to conduct prediction at a macroscopic level relating to an entire road network, with a time scale of longer than 1 second.

103. The EASS of claim 98, wherein the vehicle component comprises a Vehicle-based Crash Avoidance Subsystem supporting crash avoidance assistance for the vehicle and providing essential control and takeover,
wherein the Vehicle-based Crash Avoidance Subsystem comprises a Vehicle-based Crash Avoidance Subsystem Data Processing Unit, a Crash Avoidance Assistant Unit, a Vehicle Control and Coordination Unit, a Vehicle Takeover and Control Unit, and a Human Takeover and Control Unit,
wherein the Vehicle-based Crash Avoidance Subsystem Data Processing Unit is configured to receive and process the input data from other subsystems;
wherein the Crash Avoidance Assistant Unit is configured to analyze the feasibility of crash avoidance and provide crash avoidance strategies to support crash avoidance;
wherein the Vehicle Control and Coordination Unit is configured to coordinate other vehicles to be involved in the potential crash and send control instructions to other vehicles to support crash avoidance;
wherein the Vehicle Takeover and Control Unit is configured to provide takeover and control of the vehicle after receiving control instructions from the cloud component to support crash avoidance; and
wherein the Human Takeover and Control Unit is configured to provide takeover and control by the human driver to support crash avoidance.

104. The EASS of claim 98, wherein the Cloud-based Crash Impact Reduction Subsystem is configured to use a workflow as follows:
a) the Crash Digital Twin Unit simulates the process and outcomes of the traffic crash;
b) the Candidate Strategy Generation Unit analyzes the simulated data from the Crash Digital Twin Unit and generates a set of horizontal and vertical control commands; and
c) the Takeover and Control Unit sends control instructions to the vehicle.

105. An Enterprise Active Safety system (EASS), configured to improve safety and minimize the losses from the safety events, comprising a vehicle component;
wherein the vehicle component comprises a Management and Service Subsystem, a Crash Detection Subsystem, a Vehicle-based Crash Prediction Subsystem, a Crash Warning Subsystem, and a Vehicle-based Crash Impact Reduction Subsystem;
wherein the Management and Service Subsystem comprises: a) a Management and Allocation Module configured to provide a management method of the EASS; and b) an Update and Maintenance Software Module configured to update and maintain the software of the EASS;
wherein the Vehicle-based Crash Prediction Subsystem comprises: a) a Data Fusion Unit configured to integrate real-time data from the Crash Detection Subsystem, historical data from the Management and Service Subsystem, predicted data from other surrounding vehicles, and status data from the vehicle and a cloud; and b) a Prediction Unit configured to utilize large-scale models to predict and conduct risk assessment for the vehicle at a microscopic level; and
wherein the Vehicle-based Crash Impact Reduction Subsystem comprises: a) a Vehicle-based Crash Impact Reduction Subsystem Data Processing Unit configured to integrate the crash detection results from the Crash Detection Subsystem, crash prediction results from the Vehicle-based Crash Prediction Subsystem, crash warning results from the Crash Warning Subsystem, and historical safety data from the Management and Service Subsystem; b) an Assessment Unit configured to quantitatively evaluate the risks associated with each command through cost-benefit analysis and risk assessment models, and their expected benefits in terms of safety and overall system performance; and c) a Takeover and Control Unit configured to take control of the vehicle by receiving control instructions from the cloud.

106. The EASS of claim 105, wherein the Management and Service Subsystem is configured to perform a method comprising:
a) selecting and communicating information or results between subsystems of the EASS; and/or
b) selecting a subsystem based on a host component, a driving environment, and a vehicle intelligence level.

107. The EASS of claim 105, wherein the Crash Detection Subsystem comprises a Crash Detection Subsystem Data Processing Unit, a Crash Identification Unit, and a Crash Validation Unit,
wherein the Crash Detection Subsystem Data Processing Unit is configured to process the collected information from the vehicle component and the historical data from the Crash Management and Service Subsystem;
wherein the Crash Identification Unit is configured to identify the crash type and severity level; and
wherein the Crash Validation Unit is configured to validate the accuracy and confidence of the identified crash data.

108. The EASS of claim 107, wherein the Crash Detection Subsystem is configured to generate outputs comprising one or more of the following detection results:
a) information of past crashes, wherein the Crash Detection Subsystem sends output data to the Crash Warning Subsystem and the Management and Service Subsystem;
b) information of predicted crashes, wherein the Crash Detection Subsystem sends output data to the Vehicle-based Crash Prediction Subsystem, the Crash Warning Subsystem, the Vehicle-based Crash Impact Reduction Subsystem, and the Management and Service Subsystem; and/or
c) information of unsafe acts and near misses, wherein the Crash Detection Subsystem sends output data to one or more of the Vehicle-based Crash Prediction Subsystem, the Crash Warning Subsystem, and the Management and Service Subsystem.

109. The EASS of claim 105, wherein the Vehicle-based Crash Prediction Subsystem is configured to provide Microscopic Level Prediction, Mesoscopic Level Prediction, and Macroscopic Level Prediction,
wherein the Microscopic Level Prediction is configured to conduct prediction at a microscopic level relating to an individual vehicle, including longitudinal movements and lateral movements, with a time scale of less than 10 milliseconds;
wherein the Mesoscopic Level Prediction is configured to conduct prediction at a mesoscopic level relating to road corridors and segments, with a time scale from 10 to 1000 milliseconds; and
wherein the Macroscopic Level Prediction is configured to conduct prediction at a macroscopic level relating to an entire road network, with a time scale of longer than 1 second.

110. The EASS of claim 105, wherein the Crash Warning Subsystem comprises a Crash Warning Subsystem Data Processing Unit, a Warning Message Computing Unit, and a Warning Execution Unit,
wherein the Crash Warning Subsystem Data Processing Unit is configured to receive and process incident information comprising accidents, severe weather information, and construction data from other subsystems;
wherein the Warning Message Computing Unit is configured to generate computed messages for the vehicle component to activate warnings on devices; and
wherein the Warning Execution Unit is configured to utilize the warning devices on the vehicle component to execute received warning messages.

111. The EASS of claim 105, wherein the Vehicle-based Crash Impact Reduction Subsystem is configured to use a workflow as follows:
a) the Vehicle-based Crash Prediction Subsystem Data Processing Unit integrates input data;
b) the Assessment Unit assesses the probability of crash occurring;
c) the Assessment Unit assesses risks and expected benefits of commands and selects the commands with the least amount of loss; and
d) the Takeover and Control Unit takes control of the vehicle by receiving control instructions from the cloud.

112. An Enterprise Active Safety system (EASS), configured to improve safety and minimize the losses from the safety events, comprising a vehicle component, a cloud component, and a pedestrian component,
wherein the vehicle component comprises a Management and Service Subsystem, a Crash Detection Subsystem, a Vehicle-based Crash Prediction Subsystem, and a Vehicle-based Crash Impact Reduction Subsystem;
wherein the Management and Service Subsystem comprises: a) a Management and Allocation Module configured to provide a management method of the EASS; and b) an Update and Maintenance Software Module configured to update and maintain the software of the EASS;
wherein the Vehicle-based Crash Impact Reduction Subsystem comprises a Vehicle-based Takeover and Control Unit configured to take control of the vehicle by receiving control instructions from the cloud component;
wherein the cloud component comprises a Cloud-based Crash Prediction Subsystem and a Crash Avoidance Subsystem;
wherein the Cloud-based Crash Prediction Subsystem comprises: a) a Cloud-based Crash Prediction Subsystem Data Fusion Unit configured to integrate real-time data from the Crash Detection Subsystem, historical data from the Management and Service Subsystem, predicted data from other surrounding vehicles, and status data from the vehicle and the cloud component; b) a Prediction Unit configured to utilize large-scale models to predict and conduct risk assessment for the vehicle at a microscopic level; and c) an Assessment Unit configured to assess the risk level, and evaluate potential collision scenarios, including Fatality, Serious Injury, Minor Injury, Near Miss, and Unsafe Act; and
wherein the pedestrian component comprises a Crash Warning Subsystem comprising: a) a Crash Warning Subsystem Data Processing Unit configured to receive and process incident information comprising accidents, severe weather information, and construction data from other subsystems; and b) a Warning Message Computing Unit configured to generate computed messages for the pedestrian component to activate warnings on devices.

113. The EASS of claim 112, wherein the management method comprises:
a) selecting and communicating information or results between subsystems of the EASS; and/or
b) selecting a subsystem based on a host component, a driving environment, and a vehicle intelligence level.

114. The EASS of claim 112, wherein the Crash Detection Subsystem comprises a Crash Detection Subsystem Data Processing Unit, a Crash Identification Unit, and a Crash Validation Unit,
wherein the Crash Detection Subsystem Data Processing Unit is configured to process the collected information from the vehicle component, and the historical data from the Crash Management and Service Subsystem;
wherein the Crash Identification Unit is configured to identify the crash type and severity level; and
wherein the Crash Validation Unit is configured to validate the accuracy and confidence of the identified crash data.

115. The EASS of claim 112, wherein the Vehicle-based Crash Prediction Subsystem is configured to provide Microscopic Level Prediction, Mesoscopic Level Prediction, and Macroscopic Level Prediction,
wherein the Microscopic Level Prediction is configured to conduct prediction at a microscopic level relating to an individual vehicle, including longitudinal movements and lateral movements, with a time scale of less than 10 milliseconds;
wherein the Mesoscopic Level Prediction is configured to conduct prediction at a mesoscopic level relating to road corridors and segments, with a time scale from 10 to 1000 milliseconds; and
wherein the Macroscopic Level Prediction is configured to conduct prediction at a macroscopic level relating to an entire road network, with a time scale of longer than 1 second.

116. The EASS of claim 112, wherein the Crash Warning Subsystem is configured to generate outputs comprising a real-time warning and/or an offline warning,
wherein the real-time warning comprises fatality crash, serious injury crash, and minor injury crash; and
wherein the offline warning comprises near miss and unsafe act.

117. The EASS of claim 112, wherein the vehicle component comprises a Vehicle-based Crash Avoidance Subsystem supporting crash avoidance assistance for the vehicle and providing essential control and takeover,
wherein the Vehicle-based Crash Avoidance Subsystem comprises a Vehicle-based Crash Avoidance Subsystem Data Processing Unit, a Crash Avoidance Assistant Unit, a Vehicle Control and Coordination Unit, a Vehicle Takeover and Control Unit, and a Human Takeover and Control Unit;
wherein the Vehicle-based Crash Avoidance Subsystem Data Processing Unit is configured to receive and process the input data from other subsystems;
wherein the Crash Avoidance Assistant Unit is configured to analyze the feasibility of crash avoidance and provide crash avoidance strategies to support crash avoidance;
wherein the Vehicle Control and Coordination Unit is configured to coordinate other vehicles to be involved in the potential crash and send control instructions to other vehicles to support crash avoidance;
wherein the Vehicle Takeover and Control Unit is configured to provide takeover and control of the vehicle after receiving control instructions from the cloud component to support crash avoidance; and
wherein the Human Takeover and Control Unit is configured to provide takeover and control by the human driver to support crash avoidance.
